SEQUENCE LISTING (9 sequences)

SEQ ID NO: 1 - DNA, 20 bp, Artificial Sequence
  Synthetic primer/probe
tgatgacaagaaagggattg

SEQ ID NO: 2 - DNA, 21 bp, Artificial Sequence
  Synthetic primer/probe
cccagtctgataggatgtgtt

SEQ ID NO: 3 - DNA, 25 bp, Artificial Sequence
  Synthetic primer/probe
tcgatcagtcacaacaagcatacca

SEQ ID NO: 4 - DNA, 20 bp, Artificial Sequence
  Synthetic primer/probe
gagagcttcagacaagcaga

SEQ ID NO: 5 - DNA, 20 bp, Artificial Sequence
  Synthetic primer/probe
tcatcttctcgatccttgag

SEQ ID NO: 6 - DNA, 21 bp, Artificial Sequence
  Synthetic primer/probe
tgttgcccaatgaccagctct

SEQ ID NO: 7 - DNA, 21 bp, Artificial Sequence
  Synthetic primer/probe
ccaacgcaccgaatagttacg

SEQ ID NO: 8 - DNA, 18 bp, Artificial Sequence
  Synthetic primer/probe
gcgctgcccatcatcatg

SEQ ID NO: 9 - DNA, 18 bp, Artificial Sequence
  Synthetic primer/probe
cctggatcggcctccgac

(19) United States
(12) Patent Application Publication
(10) Pub. No.: US 2022/0104482 A1
(43) Pub. Date: Apr. 7, 2022

(54) Compositions, Methods and Kits for Stabilizing Cells and Biological Samples

(71) Applicants: The General Hospital Corporation, Boston, MA (US); Sapere Bio, Inc., Durham, NC (US)

(72) Inventors: Mehmet Toner, Charlestown, MA (US); Rebecca Sandlin, Melrose, MA (US); Anne Knecht, Chapel Hill, NC (US); Ho Ki Wong, Newton, MA (US); Shannon N. Tessier, Framingham, MA (US); Shannon Stott, Stoneham, MA (US)

(21) Appl. No.: 17/428,453

(22) PCT Filed: Feb. 7, 2020
(86) PCT No.: PCT/US2020/017310

§ 371 Date: Aug. 4, 2021

Related U.S. Application Data
(60) Provisional application No. 62/802,684, filed on Feb. 7, 2019.

(51) Int. Cl. A01N 1/02

(52) U.S. Cl. CPC A01N 1/0226; A01N 1/0252

(57) ABSTRACT

Compositions, methods and kits are described for stabilizing cells and biological samples, allowing for storage and transportation of stabilized cells and biological samples. Cells can be stabilized in whole blood or fractionated blood. Isolated cells can also be stabilized.

### CROSS-REFERENCE TO RELATED APPLICATIONS

This application claims priority to U.S. Provisional Application No. 62/802,684, filed on Feb. 7, 2019. The entire contents of the foregoing application is incorporated herein by reference.

### STATEMENT REGARDING FEDERALLY SPONSORED RESEARCH OR DEVELOPMENT

The inventions herein were made with Government support under Grant Nos. EB002503, EB012493, and 5U01EB012493 awarded by the National Institutes of Health and the National Institute of Biomedical Imaging and Bioengineering and Grant No R44AG060888 awarded by the National Institutes of Health and the National Institute on Aging. The Government has certain rights in the inventions disclosed herein.

### FIELD OF THE DISCLOSURE

This disclosure relates to compositions, methods, and kits for stabilizing cells and other biological samples.

### BACKGROUND

Whole blood is a complex suspension that comprises red blood cells, white blood cells, platelets, exosomes, cell-free nucleotides/proteins/macromolecules, and cells from other systems such as endothelial, epithelial cells and other parenchymal cells, suspended in plasma comprising electrolytes, hormones, vitamins, antibodies, fibrinogen, mineral ions, glucose, and other compounds. Whole blood deteriorates quickly ex vivo. Degradation events such as nutrient deprivation, oxidative stress, changes in osmolarity and pH, and accumulation of toxic metabolic byproducts quickly commence. Within hours, neutrophils undergo activation, oxidative bursting, as well as necrosis and apoptosis. Blood settling causes physical stress, and exacerbates degradation by mechanically compacting necrotic cells in a confined space that accelerates collateral damage and cross-activation. Transportation of blood samples results in shaking which induces hemolysis and platelet activation. The damage to the blood samples affects the viability and functionality of the cells of interest in the sample, but also adversely impacts downstream enrichment and processing techniques in a wide spectrum of applications. For instance, shedding of surface antigens render antibody-based sorting ineffective. Red blood cell rouleaux formation may trap rare cells. And microfluidic sorting technologies are compromised by echinocytes (aged red blood cells that form spiculations), platelet activation and clotting, as well as cellular aggregation.

To further complicate preservation strategies for whole blood, hypothermic temperature ranges which can otherwise effectively suppress biochemical reactions and degradation processes have been considered incompatible, due mainly to cold-induced platelet activation. As such, in modern transfusion medicine whole blood is typically stored at room temperature and processed into various components for specialized storage within 24 hours. Given that many clinically relevant assays such as sequencing and expression profiling are best performed in centralized large medical centers or diagnostic laboratories, the logistical needs of blood storage and transportation impose severe limitations to the dissemination of next-generation blood-based medical technologies.

Finding methods to preserve whole blood and its individual immune cell components has been an intractable problem for years. Discovering such methods would open up a wide range of basic science and medical applications. Isolation of immune cell subtypes to study their cell frequency, function, and gene expression profile would advance understanding and ultimately treatment of diseases such as type 1 diabetes, a whole range of auto immune disorders, and blood cancers, among others. If patient samples can be stabilized for shipping to a centralized lab, it will greatly expand the ability of researchers to perform lineage and expression analysis studies. Traditional methods of shipping whole blood used for transfusion and biobanking compromise cell number, viability, and function of mononucleated cells of the immune system (See, e.g., Posevitz-Fejfár, A., PLOS ONE, 9(12): e115920 (2014)).

To avoid changes during shipping, some methods isolate peripheral blood mononucleated cells (PBMCs) from fresh blood and ship PBMCs cryopreserved. Unfortunately, cell numbers of certain immune cell subtypes and gene expression signatures change during cryostorage, making analysis unreliable (see, e.g., Owen, R. E. et al, 2007, J Immonol Methods). In certain instances, such as monitoring of CD4+ cell numbers in HIV patients, whole blood is collected into a fixative containing solution (such as Cyto-Chex® blood collection tubes) that preserves cell counts. While this method allows blood shipment to a central lab where an accurate CD4+ cell counts can be performed, fixation results in extensive crosslinking of cell membranes, making genomic or gene expression studies problematic if not impossible.

With recent interest in circulating cell-free RNA and genomic DNA, there are products that can be used to attempt to stabilize whole blood (such as Cyto-Chex® cell-free RNA, Cyto-Chex cell-free DNA, MagBio® Blood STASIS). The main goal of these methods is to prevent immune cells from lysing and releasing their genomic DNA into the plasma compartment. While they achieve that goal with various success rates, these products do not effectively stabilize immune cells to preserve their counts and gene expression profiles.

In CAR-T immunotherapy, patients donate white blood cells through leukapheresis (where white blood cells are removed and red cells and plasma are returned back to the body). While the goal is to collect enough of a patient's T cells to manufacture CAR-T genetically engineered clones, separation of white blood cells on-site is complicated, and therefore, the entire sample is refrigerated or frozen for shipment to the processing lab/manufacturing facility. The presence of monocytes in the sample can compromise T cells and inhibit their activation and expansion, which is essential for the production of CAR T cell therapies.

Methods to preserve functional immune cell components, including T cells, in whole blood during shipping would help solve many of these problems.

### SUMMARY

In one aspect, the disclosure provides methods of stabilizing cells in a solution, the methods including combining whole blood with a buffered solution to create a preservation solution; wherein the preservation solution includes, consists of, or consists essentially of: the cells, a buffering agent that produces a physiological pH between 6.8 and 7.6, 0.15%-0.6% F68, 5-15 mM lactobionate, and an anti-coagulant; and storing the preservation solution at a temperature between about −5 and about 15 degrees Celsius. In some embodiments, the temperature range includes from about −196 to about 20, 25, or 30 degrees Celsius, as described herein.

In certain embodiments, the preservation solution includes, consists of, or consists essentially of, 25 mM HEPES at pH7.2, 0.3% F68, 10 mM lactobionate, 11.2 mM trisodium citrate, 6.2 mM citric acid, and 20.4 mM dextrose. In certain embodiments, the preservation solution further includes 10 mM Trolox® or 10 mM Ascorbic Acid. In certain embodiments, the cells comprise one or more of T cells, B cells, macrophages, white blood cells, red blood cells, and circulating cells. In certain embodiments, the combining the whole blood with a buffered solution comprises adding whole blood to a tube containing the buffered solution at a concentration to create the preservation solution.

In certain embodiments, the methods of stabilizing cells in a solution further include preparing a shipping package that includes: the preservation solution; a cold storage device, such as a refrigerator or freezer, to keep the preservation solution at a temperature between about −5 and about 15 degrees Celsius while in the shipping package; and a temperature sensor, e.g., a thermometer or thermostat, to monitor the temperature of the preservation solution during the duration that the preservation solution remains in the shipping package; and storing the preservation solution at a temperature between about −5 and about 15 degrees Celsius, e.g., for up to or at least 48 hours, or longer, as described herein.

In certain embodiments, the methods of stabilizing cells in a solution include preserving cell gene expression or cell protein expression. In certain embodiments, the methods of stabilizing cells in a solution include preserving cell function.

In another aspect, the disclosure provides methods of stabilizing cells in a solution, the methods including combining whole blood with a dry composition to create a preservation solution; wherein the preservation solution includes, consists of, or consists essentially of: the cells, a buffering agent that produces a physiological pH between about 6.8 and about 7.6, about 0.15% to about 0.6% F68, about 5 to about 15 mM lactobionate, and an anti-coagulant; and storing the preservation solution at a temperature between about −5 and about 15 degrees Celsius. In certain embodiments, the preservation solution includes, consists of, or consists essentially of 25 mM HEPES at pH7.2, 0.3% F68, 10 mM lactobionate, 11.2 mM trisodium citrate, 6.2 mM citric acid, and 20.4 mM dextrose. In certain embodiments, the preservation solution further includes 10 mM Trolox or 10 mM Ascorbic Acid. In certain embodiments, the cells include one or more of T cells, B cells, macrophages, white blood cells, red blood cells, and/or circulating cells. In certain embodiments, combining the whole blood with a dry composition includes adding whole blood to a tube including the dry composition at a concentration to create the preservation solution.

In certain embodiments, the methods of stabilizing cells in a solution further include preparing a shipping package including or containing: the preservation solution; a cold storage device to keep the preservation solution at a temperature between about −5 and about 15 degrees Celsius while in the shipping package; and a temperature sensor to monitor the temperature of the preservation solution during the duration that the preservation solution remains in the shipping package; and storing the preservation solution at a temperature between about −5 and about 15 degrees Celsius, e.g., for up to or at least 48 hours, or for longer periods of time as described herein.

In certain embodiments, the methods of stabilizing cells include preserving cell gene expression or cell protein expression. In certain embodiments, the stabilizing cells comprises preserving cell function.

In another aspect, the disclosure provides methods of stabilizing T cells in a solution, the methods including combining the T cells with a buffered solution to create a preservation solution; wherein the preservation solution includes, consists or, or consists essentially of: the T cells, a buffering agent that produces a physiological pH between 6.8 and 7.6, 0.15%-0.6% F68, 5-15 mM lactobionate, and an anti-coagulant; and storing the preservation solution at a temperature between −5 and 15 degrees Celsius. In certain embodiments, the preservation solution includes or consists or, or consists essentially of 25 mM HEPES at pH7.2, 0.3% F68, 10 mM lactobionate, 11.2 mM trisodium citrate, 6.2 mM citric acid, and 20.4 mM dextrose. In certain embodiments, the preservation solution further includes 10 mM Trolox or 10 mM Ascorbic Acid. In certain embodiments, the step of combining the T cells with a buffered solution includes mixing T cells isolated from whole blood to the buffered solution at a concentration to create the preservation solution. In certain embodiments, the step of combining the T cells with a buffered solution includes suspending pelleted T cells in the buffered solution. In certain embodiments, the step of combining the T cells with a buffered solution includes adding whole blood to a tube that contains or includes the buffered solution at a concentration to create the preservation solution.

In certain embodiments, the methods of stabilizing T cells in a solution further include preparing a shipping package that contains or includes: the preservation solution; a cold storage device to keep the preservation solution at a temperature between about −5 and about 15 degrees Celsius while in the shipping package; and a temperature sensor to monitor the temperature of the preservation solution during the duration that the preservation solution remains in the shipping package; and storing the preservation solution at a temperature between about −5 and about 15 degrees Celsius, e.g., for up to or at least 48 hours, or longer, as described herein.

In certain embodiments, the methods of stabilizing T cells include preserving T cell gene expression or T cell protein expression. In certain embodiments, the methods of stabilizing T cells includes comparing the expression levels of one or more of CD3G, IGFBP3, TP53, and/or HIF1A in T cells in a preservation solution to baseline expression levels of those markers; and, determining that the T cells are stabilized if the expression levels of one or more of CD3G, IGFBP3, TP53, and/or HIF1A in the T cells in the preservation solution are within about 40% of a baseline for each gene expression product. In certain embodiments, the stabilization of T cells includes preserving T cell function or T cell counts.

In another aspect, the disclosure features methods of stabilizing T cells in a solution, the methods including combining the T cells with a dry composition to create a preservation solution; wherein the preservation solution includes, consists of, or consists essentially of: the T cells, a buffering agent that produces a physiological pH between 6.8 and 7.6, 0.15%-0.6% F68, 5-15 mM lactobionate, and an anti-coagulant; and storing the preservation solution at a temperature between about −5 and about 15 degrees Celsius. In certain embodiments, the preservation solution includes, consists of, or consists essentially of 25 mM HEPES at pH 7.2, 0.3% F68, 10 mM lactobionate, 11.2 mM trisodium citrate, 6.2 mM citric acid, and 20.4 mM dextrose.

In certain embodiments, the preservation solution further includes 10 mM Trolox or 10 mM Ascorbic Acid. In certain embodiments, the step of combining the T cells with a dry composition to create a preservation solution includes adding T cells suspended in a resuspension solution to the dry composition to create a preservation solution. In certain embodiments, the step of combining the T cells with a dry composition to create a preservation solution includes suspending the dry composition in a resuspension solution and adding the resuspension solution to the T cells. In certain embodiments, the step of combining the T cells with a dry composition includes adding whole blood to a tube including or containing the dry composition at a concentration to create the preservation solution.

In certain embodiments, the methods of stabilizing T cells in a solution further include preparing a shipping package that contains: the preservation solution; a cold storage device to keep the preservation solution at a temperature between about −5 and about 15 degrees Celsius while in the shipping package; and a temperature sensor to monitor the temperature of the preservation solution during the duration that the preservation solution remains in the shipping package; and storing the preservation solution at a temperature between about −5 and about 15 degrees Celsius, e.g., for up to or at least 48 hours or for far longer, as described herein.

In certain embodiments, the methods of stabilizing T cells include preserving T-cell gene expression or T-cell protein expression. In certain embodiments, stabilizing T cells includes comparing the expression levels of one or more of CD3G, IGFBP3, TP53, and/or HIF1A in T cells in a preservation solution to baseline expression levels of those markers; and, determining that the T cells are stabilized if the expression levels of one or more of CD3G, IGFBP3, TP53, and/or HIF1A in the T cells in the preservation solution are within about 40% of baseline for each gene expression product. In certain embodiments, stabilization of T cells includes preserving T-cell function.

In another aspect, the disclosure provides methods of stabilizing peripheral blood mononucleated cells in a solution, the methods including combining the peripheral blood mononucleated cells with a buffered solution to create a preservation solution; wherein the preservation solution includes, consists of, or consists essentially of: the peripheral blood mononucleated cells, a buffering agent that produces a physiological pH between 6.8 and 7.6, 0.15%-0.6% F68, 5-15 mM lactobionate, and an anti-coagulant; and storing the preservation solution at a temperature between about −5 and about 15 degrees Celsius. In certain embodiments, the preservation solution includes, consists or, or consists essentially of 25 mM HEPES at pH7.2, 0.3% F68, 10 mM lactobionate, 11.2 mM trisodium citrate, 6.2 mM citric acid, and 20.4 mM dextrose. In certain embodiments, the preservation solution further includes 10 mM Trolox or 10 mM Ascorbic Acid.

In certain embodiments, the step of combining the peripheral blood mononucleated cells with a buffered solution includes mixing peripheral blood mononucleated cells isolated from whole blood to the buffered solution at a concentration to create the preservation solution. In certain embodiments, the step pf combining the peripheral blood mononucleated cells with a buffered solution includes suspending pelleted peripheral blood mononucleated cells in the buffered solution. In certain embodiments, the step of combining the peripheral blood mononucleated cells with a buffered solution includes adding whole blood to a tube that includes or contains the buffered solution at a concentration to create the preservation solution.

In certain embodiments, the methods of stabilizing peripheral blood mononucleated cells in a solution further include preparing a shipping package that contains: the preservation solution; a cold storage device to keep the preservation solution at a temperature between about −5 and about 15 degrees Celsius while in the shipping package; and a temperature sensor to monitor the temperature of the preservation solution during the duration that the preservation solution remains in the shipping package; and storing the preservation solution at a temperature between about −5 and about 15 degrees Celsius, e.g., for up to or at least 48 hours, or longer, as described herein.

In certain embodiments of these methods, stabilizing peripheral blood mononucleated cells includes preserving T cell gene expression or T cell protein expression. In certain embodiments, stabilizing peripheral blood mononucleated cells includes comparing the expression levels of any one or more of CD3G, IGFBP3, TP53, and/or HIF1A in peripheral blood mononucleated cells in a preservation solution to baseline expression levels of those markers; and, determining that the peripheral blood mononucleated cells are stabilized if the expression levels of the one or more of CD3G, IGFBP3, TP53, and/or HIF1A in the peripheral blood mononucleated cells in the preservation solution are within about 40% of a baseline of each gene expression product.

In certain embodiments, the step of stabilizing peripheral blood mononucleated cells includes comparing the expression levels of any one or more of CD3G, CD16, CD19, IGFBP3, TP53, and/or HIF1A in peripheral blood mononucleated cells in a preservation solution to baseline expression levels of those markers; and, determining that the peripheral blood mononucleated cells are stabilized if the expression levels of CD3G, CD16, CD19, IGFBP3, TP53, and HIF1A in the peripheral blood mononucleated cells in the preservation solution are within about 40% of a baseline of each gene expression product. In certain embodiments, the step of stabilization of peripheral blood mononucleated cells includes preserving T cell function or T cell counts.

In another aspect, the disclosure provides methods of stabilizing peripheral blood mononucleated cells in a solution, the methods including combining the peripheral blood mononucleated cells with a dry composition to create a preservation solution; wherein the preservation solution includes, consists of, or consists essentially of: the peripheral blood mononucleated cells, a buffering agent that produces a physiological pH between about 6.8 and about 7.6, about 0.15%-0.6% F68, about 5-15 mM lactobionate, and an anti-coagulant; and storing the preservation solution at a temperature between about −5 and about 15 degrees Celsius. In certain embodiments, the preservation solution comprises 25 mM HEPES at pH7.2, 0.3% F68, 10 mM lactobionate, 11.2 mM trisodium citrate, 6.2 mM citric acid, and 20.4 mM dextrose. In certain embodiments, the preservation solution further includes 10 mM Trolox or 10 mM Ascorbic Acid.

In certain embodiments, the methods of combining the peripheral blood mononucleated cells with a dry composition to create a preservation solution include adding peripheral blood mononucleated cells suspended in a resuspension solution to the dry composition to create a preservation solution. In certain embodiments, the methods of combining the peripheral blood mononucleated cells with a dry composition to create a preservation solution include suspending the dry composition in a resuspension solution and adding the resuspension solution to the peripheral blood mononucleated cells. In certain embodiments, the methods of combining the peripheral blood mononucleated cells with a buffered solution include adding whole blood to a tube containing the buffered solution at a concentration to create the preservation solution.

In certain embodiments, methods of stabilizing peripheral blood mononucleated cells in a solution further include preparing a shipping package that includes or contains: the preservation solution; a cold storage device to keep the preservation solution at a temperature between about −5 and about 15 degrees Celsius while in the shipping package; and a temperature sensor to monitor the temperature of the preservation solution during the duration that the preservation solution remains in the shipping package; and storing the preservation solution at a temperature between about −5 and about 15 degrees Celsius for up to 48 hours.

In certain embodiments, the step of stabilizing peripheral blood mononucleated cells includes preserving T-cell gene expression or T-cell protein expression. In certain embodiments, the step of stabilizing peripheral blood mononucleated cells includes comparing the expression levels of any one or more of CD3G, IGFBP3, TP53, and/or HIF1A in peripheral blood mononucleated cells in a preservation solution to baseline expression levels of those markers; and, determining that the peripheral blood mononucleated cells are stabilized if the expression levels of any one or more of CD3G, IGFBP3, TP53, and/or HIF1A in the peripheral blood mononucleated cells in the preservation solution are within about 40% of baseline of each of the gene expression products. In certain embodiments, the step of stabilizing peripheral blood mononucleated cells includes comparing the expression levels of any one or more of CD3G, CD16, CD19, IGFBP3, TP53, and/or HIF1A in peripheral blood mononucleated cells in a preservation solution to baseline expression levels of those markers; and, determining that the peripheral blood mononucleated cells are stabilized if the expression levels of any one or more of CD3G, CD16, CD19, IGFBP3, TP53, and/or HIF1A in the peripheral blood mononucleated cells in the preservation solution are within about 40% of baseline of each of the gene expression products. In certain embodiments, the step of stabilization of peripheral blood mononucleated cells includes preserving T-cell function.

In yet another aspect, the disclosure provides compositions for the stabilization of cells within a specific volume of whole blood, wherein after addition of the specific volume of whole blood, the composition includes, consists or, or consists essentially of: one or more buffering agents in concentrations effective to produce a physiological pH between about 6.8 and about 7.6, about 0.15%-0.6% F68, about 5-15 mM lactobionate, and an anti-coagulant. In certain embodiments, after the addition of the whole blood, the compositions include, consists of, or consists essentially of 25 mM HEPES at pH7.2, 0.3% F68, 10 mM lactobionate, 11.2 mM trisodium citrate, 6.2 mM citric acid, and 20.4 mM dextrose. In certain embodiments, the compositions for the stabilization of cells are stable when stored for up to one year prior to the addition of the whole blood. In certain embodiments, after the addition of the whole blood, the compositions further include 10 mM Trolox or 10 mM Ascorbic Acid.

In certain embodiments, the disclosure provides compositions for the stabilization of cells suspended in a specific volume of a solution, wherein after addition of the specific volume of the solution, the compositions include, consist of, or consist essentially of: one or more buffering agents in concentrations effective to produce a physiological pH between about 6.8 and about 7.6, about 0.15%-0.6% F68, about 5-15 mM lactobionate, and an anti-coagulant. In certain embodiments, after the addition of the solution, the compositions include, consist of, or consist essentially of 25 mM HEPES at pH7.2, 0.3% F68, 10 mM lactobionate, 11.2 mM trisodium citrate, 6.2 mM citric acid, and 20.4 mM dextrose. In certain embodiments, the compositions for the stabilization of cells are stable when stored for up to one year prior to the addition of the solution. In certain embodiments, after the addition of the solution, the compositions further include 10 mM Trolox or 10 mM Ascorbic Acid.

In another aspect, the disclosure provides kits for stabilizing cells, including: a) a container for collecting a set volume of whole blood including a composition as described herein, wherein after addition of the set volume of whole blood, the composition includes, consists of, or consists essentially of: one or more buffering agents in concentrations effective to produce a physiological pH between about 6.8 and 7.6, about 0.15%-0.6% F68, about 5-15 mM lactobionate, and an anti-coagulant; b) packaging to secure the container containing the preservation solution for shipping; c) a cold storage device to keep the preservation solution at a temperature between about −5 and about 15 degrees Celsius while in the packaging; and d) a temperature sensor to monitor the temperature of the preservation solution during the duration that the preservation solution remains in the shipping package. In certain embodiments, the container includes or is a tube.

In certain embodiments, the container includes or is a bag. In certain embodiments, the container is under vacuum prior to the addition of the set volume of whole blood. In certain embodiments, the kit further includes at least one of: a needle, a syringe, a set of instructions, or a timer. In certain embodiments, after addition of the set volume of whole blood, the composition includes, consists or, or consists essentially of 25 mM HEPES at pH7.2, 0.3% F68, 10 mM lactobionate, 11.2 mM trisodium citrate, 6.2 mM citric acid, and 20.4 mM dextrose. In certain embodiments, after addition of the set volume of whole blood, the composition further includes 10 mM Trolox or 10 mM Ascorbic Acid.

In another aspect, the disclosure provides kits for stabilizing cells, including: a) a container for collecting a set volume of whole blood comprising a buffered solution, wherein a preservation solution is formed after addition of the set volume of whole blood, wherein the preservation solution includes, consists, or consists essentially of: cells, one or more buffering agents at a concentration effective to produce a physiological pH between about 6.8 and about 7.6, about 0.15%-0.6% F68, about 5-15 mM lactobionate, and an anti-coagulant; b) packaging to secure the container containing the preservation solution for shipping; c) a cold storage device to keep the preservation solution at a temperature between about −5 and about 15 degrees Celsius while in the packaging; and d) and a temperature sensor to monitor the temperature of the preservation solution during the duration that the preservation solution remains in the shipping package.

In certain embodiments, the container includes or is a tube. In certain embodiments, the container includes or is a bag. In certain embodiments, the container is under vacuum prior to the addition of the set volume of whole blood. In certain embodiments, the kit further includes at least one of: a needle, a syringe, a set of instructions, or a timer. In certain embodiments, after addition of the set volume of whole blood, the composition includes, consists of, or consists essentially of: 25 mM HEPES at pH7.2, 0.3% F68, 10 mM lactobionate, 11.2 mM trisodium citrate, 6.2 mM citric acid, and 20.4 mM dextrose. In certain embodiments, after addition of the set volume of whole blood, the composition further includes 10 mM Trolox or 10 mM Ascorbic Acid.

In yet another aspect, the disclosure provides methods of stabilizing a biological sample, the methods including obtaining a biological sample from a subject and introducing the following bio-stabilization agents to the biological sample to create a preservation solution: a) at least one anti-shearing agent; b) at least one impermeant selected from trehalose and lactobionate; and c) one or more of: i) a buffering solution; ii) at least one antioxidant; iii) at least one anti-coagulant; iv) at least one anti-inflammatory agent; and v) at least one nutrient supplement. In certain embodiments, the at least one anti-shearing agent is selected from one or more of F68, Ficoll 70 kDa, Dextran 40 kDa, and/or PEG 8 kDa. In certain embodiments, the buffering solution includes or is HEPES or Sodium Bicarbonate.

In certain embodiments, the at least one antioxidant is selected from one or more of Trolox, NALC, Ascorbic Acid, Lipoic Acid, Lipoic Acid/DHLA, and/or GSH/DHLA. In certain embodiments, the at least one anti-coagulant is selected from one or more of citrate and EDTA. In certain embodiments, the at least one anti-inflammatory agent is dexamethasone. In certain embodiments, the at least one nutrient supplement is selected from platelet poor plasma and a cell culture media. In certain embodiments, the biological sample is blood, e.g., whole blood. In certain embodiments, the preservation solution is stored at a temperature between about 2-8° C. for up to about 72 hours. In certain embodiments, the at least one anti-shearing agent is added to produce a final concentration of up to about 10% w/v of the at least one anti-shearing agent in the preservation solution. In certain embodiments, the at least one impermeant is added to achieve a final concentration of up to about 150 mM in the preservation solution. In certain embodiments, the at least one antioxidant is added to achieve a final concentration of up to about 250 mM in the preservation solution.

In another aspect, the disclosure provides compositions for stabilizing cells in a solution, the compositions including an Acid Citrate Dextrose (ACD) anticoagulant, a platelet inhibitor, e.g., tirofiban, e.g., 0.5 ug/mL tirofiban, and about 0.25% to about 3% Ficoll70. In some embodiments, the compositions further include about 10 mM Trolox, about 10 mM Lactobioante, about 25 mM HEPES, and about 0.3% F68. In another aspect, the disclosure provides compositions for stabilizing cells in a solution, the compositions including an ACD anticoagulant, a platelet inhibitor, e.g., tirofiban, e.g., 0.5 ug/mL tirofiban, about 10 mM Trolox, about 10 mM Lactobioante, about 25 mM HEPES, and about 0.3% F68, e.g., without Ficoll.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

Other features and advantages of the invention will be apparent from the following detailed description, and from the claims.

### BRIEF DESCRIPTION OF THE DRAWINGS

FIG. 1. T cell surface receptors and extracellular gene expression are altered in stored blood. Blood samples from 10 donors were collected into anti-coagulant containing blood tubes and stored at room temperature for 24-30 h. At that point T cells were isolated by negative selection and gene expression of T cell receptor CD3 (gamma subunit) or an intracellular gene CDKN2A were measured by RT-PCR. Expression of T cell marker decreased by at least 20% in 6/10 donors (light grey bar) and expression of CDKN2A (black bar) decreased by at least 20% or was below detection (NQ) in 9/10 donors. CD3G and CDKN2A expression levels in T cells isolated from freshly-drawn blood were set to 1 for each donor (horizontal line).

FIG. 2. T cell surface receptors and extracellular gene expression can be preserved in whole blood. Blood samples from 2 donors were collected into anti-coagulant containing blood tube, preserved by adding CWA buffered solution and refrigerated for 29 h (Day 1) or 50 h (Day 2). At that point T cells were isolated by negative selection and gene expression of T cell receptor CD3 (gamma subunit) or an intracellular gene CDKN2A were measured by RT-PCR. Both, expression of T cell marker (light grey bar) and expression of CDKN2A (black bar) was preserved as compared to gene expression in T cells isolated from freshly drawn samples (horizontal line).

FIG. 3. Refrigeration of preserved whole blood is necessary to achieve acceptable levels of preservation of T cell surface receptors and extracellular gene expression. Blood samples from 2 donors were collected into anti-coagulant containing blood tube, preserved by adding CWT buffered solution and refrigerated or stored at room temperature for 29 h (Day 1) or 50 h (Day 2). At that point T cells were isolated by negative selection and gene expression of T cell receptor CD3 (gamma subunit) or an intracellular gene CDKN2A were measured by RT-PCR. For both donors, refrigeration at 4 degrees preserved CD3G (light grey bar) and CDKN2A (black bar) expression to within 40% from expression levels in freshly isolated T cells. Blood stored at room temperature had altered CD3G and CDKN2A expression even when buffered solution was added. CD3G and CDKN2A expression levels in T cells isolated from freshly-drawn blood were set to 1 for each donor (horizontal line).

FIG. 4. Preservation buffer is effective in maintaining cell counts and gene expression of isolated T cells. T cells were isolated from anti-coagulated blood samples within 1 h of draw and counted. Cells were resuspended in buffered solution at 1.5−2×10⁶ cells/ml and stored at 4 degrees for 24 h. At this time point, cells were re-counted and used to analyze gene expression. At least 80% of T cells remained viable (dark grey bar), as determined by Trypan blue staining, during storage. Consistent with data in FIGS. 2 and 3, expression of CD3G marker (light grey bar) as well as expression of intracellular CDKN2A gene (black bar) were also preserved. T cell number at Day 0 was set at 1 for each donor. CD3G and CDKN2A expression levels in T cells isolated from freshly-drawn blood were set to 1 for each donor.

FIG. 5. Effectiveness of buffered solution to preserve T cells does not decline with prolonged storage at room temperature. Blood samples from 2 donors were collected into anti-coagulant containing blood tubes and preserved by adding buffered solution that was mixed the day prior to blood draw (freshly-made) or pre-made and stored at room temperature for at least 5 months. Preserved blood was stored refrigerated for at least 50 hours, at which point T cells were isolated and tested. Expression of T cell marker CD3G (light grey bar) as well as intracellular gene CDKN2A (black bar) was preserved by both solutions. CD3G and CDKN2A expression levels in T cells isolated from freshly-drawn blood were set to 1 for each donor (horizontal line).

FIG. 6. Effectiveness of buffered solution to preserve T cells does not decline with extended storage at room temperature. Blood samples from 2 donors were collected into anti-coagulant containing blood tubes and preserved by adding buffered solution that was mixed the day prior to blood draw (freshly-made) or pre-made and stored at room temperature for at least 12 months. Preserved blood was stored refrigerated for at least 48 hours, at which point T cells were isolated and tested. Expression of T cell marker CD3G (light grey bar) as well as intracellular gene CDKN2A (black bar) was preserved by both solutions. CD3G and CDKN2A expression levels in T cells isolated from freshly-drawn blood were set to 1 for each donor (horizontal line).

FIG. 7. Three different preservation solutions with different concentrations of components all effectively preserve blood. A single preservation solution was added to blood at three different ratios to create three different preservation solutions designated BSS-A, BSS-B, and BSS-C as described in Example 7. Blood samples from 2 donors were collected into anti-coagulant containing blood tubes and preserved by adding buffered solution to create three different preservations solutions designated BSS-A; BSS-B; and BSS-C. Preserved blood was stored refrigerated for at least 48 hours, at which point T cells were isolated and tested. Expression of T cell marker CD3G (light grey bar) as well as intracellular gene CDKN2A (black bar) was preserved by both solutions. CD3G and CDKN2A expression levels in T cells isolated from freshly-drawn blood were set to 1 for each donor (horizontal line).

FIG. 8. Preservation solution is effective at preserving gene expression of a panel of T-cell associated genes (CD3G, IFGBP3, HIF1A, and TP53). Blood samples from 2 donors were collected into anti-coagulant containing blood tubes and preserved by adding buffered solution. Samples were stored refrigerated for at least 24 hours, or at room temperature for at least 24 hours, at which point T cells were isolated and tested. Stabilized samples (light grey bars) retained expression levels within 40% of baseline levels (RQs between 0.6 and 1.4 (dashed horizontal lines)) for all genes. For unstabilized samples (black bars) stored at 20° C., expression levels of CD3G, IFGBP3, and TP53 dropped to at or below one-third of baseline expression (RQs between 0.18 and 0.34), while expression of HIF1A increased 2-fold in unstabilized samples.

FIG. 9. Preservation solution is effective at preserving gene expression of a panel of genes associated with different cell types (CD3G, CD16, CD19, IFGBP3, HIF1A, IFNG, and TP53). Blood samples from 2 donors were collected into anti-coagulant containing blood tubes and preserved by adding buffered solution. Samples were stored refrigerated for at least 24 hours, or at room temperature for at least 24 hours, at which point cells were isolated and tested. After 24 hours, 4° C. stabilized samples (light grey bars) retained expression levels within 12% of baseline levels for all genes tested (well within the 40% of baseline levels marked by the dashed horizontal lines) (RQs between 0.98 and 1.12). For unstabilized samples (black bars) stored 24 hours at 20° C., expression levels of CD3G, CD16, CD19, IFGBP3, and TP53 dropped to at or below one-third of baseline expression (RQs between 0.19 and 0.32), while expression of HIF1A, and IFNG increased between 4.65- to 8.6-fold in unstabilized samples.

FIG. 10. Cell viability as a function of concentration of various impermeants. The impermeants Lactobionate, Mannitol, and Trehalose were tested at concentrations between 0-100 mM, as described in Example 10.

FIG. 11. Cell viability as a function of concentration of various polymers. The polymers F68, PEG 8 KDa, Ficoll 70 kDa, and Dextran 40 kDa were tested at concentrations between 0-3% weight/volume, as described in Example 10.

FIG. 12. Cell viability as a function of concentration of various antioxidants. The antioxidants Trolox, Ascorbic Acid, Lipoic Acid, Lipoic Acid/DHLA, and GSH/DHLA were tested at concentrations between 0-10 mM, as described in Example 10.

FIG. 13. Cell viability as a function of concentration of various buffers and additional agents. The bio-stabilization agents NALC, Glycine, and HEPES were tested at various concentrations, as described in Example 10. NALC was tested at concentrations between 0-40 mM. Glycine was tested at concentrations between 0-20 mM. And HEPES was tested at concentrations between 0-50 mM.

### DETAILED DESCRIPTION

Section headings used herein are for organizational purposes only and are not to be construed as limiting the subject matter described. Unless otherwise defined, all technical and scientific terms used herein have the same meaning as commonly understood by one of ordinary skill in the art to which this invention belongs. Methods and materials are described herein for use in the present invention; other, suitable methods and materials known in the art can also be used. The materials, methods, and examples are illustrative only and not intended to be limiting. All publications, patent applications, patents, sequences, database entries, and other references mentioned herein are incorporated by reference in their entirety. In case of conflict, the present specification, including definitions, will control.

The following terms, unless otherwise indicated, shall be understood to have the following meanings:

The term “cell preservation” refers to preserving at least one of cell function, cell protein expression, cell gene expression, or gene expression signature. In certain embodiments as described herein, methods of cell preservation include stabilizing cells by preserving at least one of cell function, cell protein expression, cell gene expression, or gene expression signature in a preservation buffer.

The term “cell function” refers to the normal functions of the cell in vivo. Cell function is generally determined by the combination of the lineage of the cell, the proliferation status of the cell, and the activation status of the cell. The lineage status, proliferation status, and activation status can all be detected by detecting gene expression, protein expression, or a combination of gene and protein expression. For example, and not limitation, the lineage status of a cell can often be determined by the surface receptors on a cell, which allows for affinity based cell sorting.

In certain embodiments, cell function is preserved to the extent that the preserved cell has the same function as it had in vivo. In certain embodiments, at least one aspect of cell function is preserved, even if not all functions of the cell are preserved. In certain embodiments, a cell function is preserved if the cell continues to perform that function at up to 50% effectiveness, even if said function is reduced compared to cells that have been freshly removed from the body. In certain embodiments, a cell function is preserved if the cell continues to perform that function at up to 95%, 90%, 85%, 80%, 75%, 70%, 65%, 60%, or 55%, even if said function is reduced compared to endogenous cells that have not been removed from the body or preserved.

The term “cell protein expression” refers to proteins expressed on a surface or inside a cell or secreted by a cell. In certain embodiments, cell protein expression is preserved if cell protein expression is detectable. In certain embodiments, cell protein expression is preserved if the measured levels of cell protein expression are within 10-200% of the cell protein expression of identical cells in a freshly isolated sample or in vivo. In certain embodiments, cell protein expression is preserved if the measured levels of cell protein expression are within 20-200% of the cell protein expression of identical cells in a freshly isolated sample or in vivo. In certain embodiments, cell protein expression is preserved if the measured levels of cell protein expression are within 60-140% of the cell protein expression of identical cells in a freshly isolated sample or in vivo. In certain embodiments, cell protein expression is preserved if the measured levels of cell protein expression are within 50-200% of the cell protein expression of identical cells in a freshly isolated sample or in vivo. In certain embodiments, cell protein expression can be measured either prior to or after any post-translational modifications.

The term “cell gene expression” refers to genes expressed in a cell. In certain embodiments, cell gene expression in a preserved cell is measured from total cellular RNA. In certain embodiments, cell gene expression is preserved if the measured levels of cell gene expression are within 10-200% of the cell gene expression of identical cells in a freshly isolated sample or in vivo. In certain embodiments, cell gene expression is preserved if the measured levels of cell gene expression are within 20-200% of the cell gene expression of identical cells in a freshly isolated sample or in vivo. In certain embodiments, cell gene expression is preserved if the measured levels of cell gene expression are within 60-140% of the cell gene expression of identical cells in a freshly isolated sample or in vivo. In certain embodiments, cell gene expression is preserved if the measured levels of cell gene expression are within 50-200% of the cell gene expression of identical cells in a freshly isolated sample or in vivo.

The terms “buffer solution” and “buffered solution” refer to any solution comprising a buffer. Common buffers include, but are not limited to, HEPES, Tris, phosphate buffered saline, HEPES buffered saline, sodium bicarbonate, and MOPS. In certain embodiments, a buffered solution comprises one or more buffers, chosen from any known buffers that are compatible with cell preservation and cell stabilization. In certain embodiments, a buffered solution comprises one or more components of a preservation solution. In certain embodiments, a buffer solution contributes to a preservation solution with a pH between 6.0 and 8.5, between 6.2 and 8.3, between 6.4 and 8.1, between 6.6 and 7.9, or between 6.8 and 7.6.

The term “preservation solution” refers to a solution where a biological sample is mixed with a buffered solution and the biological sample is stabilized. In certain embodiments, a preservation solution is added to cells, such as, for example, and not limitation, blood cells, and the cells are stabilized. In certain embodiments, cells stabilized in a preservation solution are stabilized in a viable and non-fixed state. In certain embodiments, a preservation solution comprises cells, a buffering agent at a physiological pH, an anti-shearing agent, an osmotic agent, and an anti-coagulant. In certain embodiments, a preservation solution further comprises an antioxidant. In certain embodiments, a preservation solution comprises: cells, a buffering agent that produces a physiological pH between 6.8 and 7.6, 0.15%-0.6% F68, 5-15 mM lactobionate, and an anti-coagulant. In certain embodiments, a preservation solution comprises cells, 25 mM HEPES at pH7.2, 0.3% F68, 10 mM lactobionate, 11.2 mM trisodium citrate, 6.2 mM citric acid, and 20.4 mM dextrose.

The term “resuspension solution” refers to a solution used to suspend dried components in a solution. Examples of dried components include, but are not limited to, a pellet in a tube, a dried coating on the interior surface of a container, or a combination of a pellet in a tube and a dried coating on the interior surface of a container. In certain embodiments, a resuspension solution comprises water. In certain embodiments, a resuspension solution comprises one or more components of a preservation solution.

In certain embodiments, a preservation solution comprises an anti-shearing agent. Anti-shearing agents help reduce the stress on preserved cells and help avoid blood settling. Blood settling not only induces mechanical stresses, but also compacts blood cells and accelerates collateral damage caused by activated and degrading leukocytes. Anti-shearing agents also prevent cell clumping and red blood cell aggregation, therefore preventing cell lysis. In certain embodiments, anti-shearing agents are large polymers, such as F68 (Poloxamer 188) or Ficoll 70, as well as molecules with similar chemical and structural properties, such as other nonionic copolymers. Examples of anti-shearing agents include but are not limited to, F68, Ficoll 70 kDa, Dextran 40 kDa, and PEG 8 kDa. In certain embodiments, an anti-shearing agent can be used in a preservation solution at concentrations between 0.1 to 15% weight/volume. In certain embodiments, an anti-shearing agent can be used in a preservation solution at a concentration of 0.5%, 1%, 1.5%, 2%, 2.5%, 3%, 3.5%, 4%, 4.5%, 5%, 5.5%, 6%, 6.5%, 7%, 7.5%, 8%, 8.5%, 9%, 9.5%, 10%, 10.5%, 11%, 11.5%, 12%, 12.5%, 13%, 13.5%, 14%, 14.5%, or 15% weight/volume.

In certain embodiments, a preservation solution comprises an osmotic agent. In certain embodiments, lactobionate provides osmotic support to cells in a preservation solution. In certain embodiments, lactobionate can be prepared for use in a preservation solution from lactobionic acid or any salts of lactobionate. In certain embodiments, impermeant osmotic agents can be used in a preservation solution at concentrations between 0.1 and 1000 mM. Other osmotic agents include, but are not limited to, mannitol, trehalose, raffinose, hydroxyethyl starch, and gluconate. In certain embodiments, osmotic agents are not permeable to the cell membrane and are called impermeant osmotic agents, or “impermeants.” Examples of impermeant osmotic agents include, but are not limited to, F68, raffinose, gluconate, lactobionate, mannitol, trehalose, and hydroxyethyl starch. In certain embodiments, impermeant osmotic agents can be used in a preservation solution at concentrations between 0.1 and 1000 mM.

The term “anti-coagulant” refers to a substance that inhibits clotting of whole blood. Anti-coagulants include, but are not limited to, low molecular weight heparins and calcium chelating agents, such as EDTA and citrate. In certain embodiments, an anti-coagulate is a composition of compounds, such as, for example, and not limitation, Acid Citrate Dextrose Solutions A and B (“ACD-A” and ACD-B″ respectively). Additional anti-coagulants include, but are not limited to, warfarin, rivaroxaban, dabigatran, apixaban, edoxaban, enoxaparin, dalteparin, fondaparinux, bivalirudin, argatroban, antithrombin III, Vitamin K antagonists, direct thrombin inhibitors, platelet inhibitors (such as tirofiban), potassium oxalate, and Factor Xa inhibitors.

The term “antioxidant” refers to a compound or substance that inhibits oxidation or reactions promoted by oxygen, peroxides or free radicals. In certain embodiments, an antioxidant inhibits oxidation of the compounds in at least one of a preservation solution, a buffering solution, a resuspension solution, and a dry composition. Examples of antioxidants include, but are not limited to, Trolox, ascorbic acid, glutathione, cysteine, methionine, citrate and EDTA. In certain embodiments, compounds may be an antioxidant and perform a second role in a solution. For example, and not limitation, in certain embodiments, EDTA functions as both an anti-coagulant and an antioxidant. In certain embodiments, an antioxidant is added to a solution primarily for its role in inhibiting oxidation or other reactions promoted by oxygen regardless of what other roles that compound might additionally have in the solution. Antioxidants can be used in an amount of about 0.5 to about 250 mM, in an amount of about 1 to about 100 mM, in an amount of about 5 to about 50 mM, or in an amount of about 5 to about 15 mM.

In certain embodiments, a preservation solution comprises an anti-inflammatory agent. Examples of anti-inflammatory agents include, but are not limited to, dexamethasone and other natural and synthetic corticosteroids.

In certain embodiments, a preservation solution comprises a nutrient supplement, for example, and not limitation, a cell culture media. In certain embodiments, a nutrient supplement comprises one or more compounds or substances that contribute to the viability of the cell type being preserved, for example, and not limitation, platelet-poor plasma, a cell culture media, glutamine, amino acids, and glucose.

In certain embodiments, cells are stabilized in a preservation solution. In certain embodiments, components of whole blood are stabilized in a preservation solution, including, but not limited to, white blood cells, red blood cells, platelets, circulating cells of non-immune origin and exosomes. Examples of cells that can be stabilized in a preservation solution include, but are not limited to, T cells, NK cells, monocytes, B cells, macrophages, neutrophils, stem cells, fetal cells from maternal blood, circulating normal and tumor cells, including, but not limited to circulating endothelial and tumor epithelial cells.

Cells for preservation can be from any source of whole blood, for example, and not limitation, arterial or venous peripheral blood. In certain embodiments, cells for preservation can be from cord blood. In certain embodiments, cells for preservation can be from any blood that contains stem cells, for example, and not limitation, cells derived from bone marrow or the lymphatic system. In certain embodiments, cells for preservation can be from any blood that contains circulating cells of non-immune origin, for example, and not limitation, circulating endothelial, mesenchymal or epithelial cells both normal and associated with a disease such as cancer. In certain embodiments, cells for preservation can be from tumor samples that contain tumor infiltrating immune cells, for example, and not limitation, tumor infiltrating lymphocytes, monocytes, or macrophages.

In certain embodiments, the preserved cells can be preserved from whole blood, in plasma, or from isolated, or partially isolated cells. For example and not limitation, preserved cells can be subsets of cells isolated from fractionated blood, or cells isolated by centrifugation, including, but not limited to, pelleted cells.

In certain embodiments, exosomes can be stabilized by a preservation solution. In certain such embodiments, components of exosomes can be identified or measured. Examples of components of exosomes include, but are not limited to, miRNA, genomic DNA fragments, cell free DNA, cell free RNA, proteins, and other components found within exosomes. In certain embodiments, a preservation solution can be used to preserve a “biological sample”. A biological sample is any sample that includes biological material. Examples of biological samples include, but are not limited to, extracellular vesicles, viruses, bacteria, fungi, organisms, tissues, whole organs, and blood.

In certain embodiments, one can measure how effectively cell function has been preserved by measuring one or more markers for cell protein expression or cell gene expression. In certain such embodiments, such markers are selected based on known genes or proteins that possess characteristic or distinctive gene expression patterns in the particular cells being targeted. For example, and not limitation, in certain embodiments, one can measure T-cell preservation by measuring cell protein expression or cell gene expression of markers indicative of preservation of T-cell viability and activation status, such as, for example, and not limitation, one or more of genes CD3G, IGFBP3, TP53, and HIF1A. In certain embodiments, one can measure general cell preservation by using one or more markers for oxidative stress and inflammation, such as, for example, and not limitation, interferon-gamma (IFNG). In certain embodiments, one can measure B-cell preservation by measuring cell protein expression or cell gene expression of markers indicative of B-cell preservation, such as, for example, and not limitation, CD19.

In certain embodiments, one can measure preservation of a subset of cells by measuring cell protein expression or cell gene expression of markers indicative of the preservation of those cells. For example, and not limitation, CD16 is expressed monocytes and macrophages, and its expression is indicative of how well those cells are preserved in the preservation solution. In certain embodiments, one can measure both cell protein expression and cell gene expression for a particular type of cell. In certain embodiments, one can measure multiple different markers for cell protein expression and/or cell gene expression that are indicative of two or more cell types to assess general cell preservation in a preservation solution or to assess cell preservation of a subset of cells, including two or more cell types. For example, and not limitation, one can measure a panel of markers including two or more of CD3G, IGFBP3, TP53, HIF1A, IFNG, CD16, and CD19 to measure the preservation of cells in a preservation solution. As another example, and not limitation, one can measure that same panel of markers to measure the preservation of peripheral blood mononuclear cells (PBMC's) in a preservation solution.

The term “baseline” refers to the gene expression level and/or protein expression level of a marker in freshly isolated cells or in vivo. In certain embodiments, a baseline level of expression for one or more markers is determined, and those levels of expression for one or more markers are compared to the expression levels of those markers in cells that have been stabilized in a preservation solution. In certain such embodiments, the effectiveness of stabilization of those cells is determined by how far the expression levels differ from the baseline.

In certain embodiments, one can measure how effectively cell function has been preserved by first isolating a subset of cells, followed by preserving the cells in preservation solution, and then measuring one or more markers for cell protein expression or cell gene expression in the preservation solution. For example, and not limitation, one can isolate T-cells from blood, preserve the isolated T-cells in preservation solution, and then measure levels of cell protein expression or cell gene expression in those T-cells. By first isolating the subset of cells one is interested in, one can then look at changes in particular markers that possess characteristic or distinctive gene expression patterns in that subset of cells without having the signal from those cells contaminated with signals from other cells that may be expressing the same markers. For example, and not limitation, one can isolate T-cells before testing markers such as CDKN2A. In certain embodiments, first isolating a subset of cells before adding those cells to preservation solution can help minimize paracrine effects from other cell types that might otherwise be present if all of the cells were in the same preservation solution.

In certain embodiments, one can measure how effectively cell function has been preserved by measuring the amount of ATP being produced. Methods of measuring cell viability by measuring levels of ATP include, but are not limited to, the Cell Titer Glo Assay. Other methods of measuring cell viability and/or cell function are known to those of skill in the art, including, but not limited to, staining with BrdU, MTTW, and XTT, WST-1, Trypan Blue reagent, and propidium iodine (PI).

In certain embodiments, one can measure how effectively cell function has been preserved by measuring two or more markers possessing characteristic or distinctive gene expression patterns in the particular cells being targeted, and requiring all of those markers to have cell protein expression and/or cell gene expression levels within a percentage of the relevant cell gene expression levels and/or cell protein expression levels of identical cells in a freshly isolated sample or in vivo. For example and not limitation, one can judge whether T-cells are stabilized by comparing expression levels of CD3G, IGFBP3, TP53, and HIF1A in T-cells in preservation solution with the expression levels of those genes in T-cells from a freshly isolated sample or in vivo, and require that the expression levels for each of those four markers not vary by more than 40% (60% to 140% range) from baseline to conclude that the T-cells have been stabilized in the preservation solution. In certain embodiments, T-cells are preserved if the expression levels of those four markers do not vary from baseline expression levels of those markers by more than 50%, 45%, 40%, 35%, 30%, 25%, 20%, 15%, 10%, or 5%. In certain embodiments, T-cells are preserved if the expression levels of the markers CD3G and HIF1A do not vary from baseline expression levels by more than 50% (Range of 50% to 150% of baseline). In certain embodiments, the cells in whole blood are preserved if the markers HIF1A and INFG do not vary from baseline expression levels by more than 50% (Range of 50% to 150% of baseline).

In certain embodiments, cells are stabilized in a preservation solution up to any one of 4, 8, 12, 18, 24, 30, 36, 42, 48, 54, 60, 66, 72, 78, 84, 90, 96, 102, 108, 114, 120, 126, 132, 138, 144, 150, 156, 162, or 168 hours, or extending for many weeks or months of storage. In certain such embodiments, the cells are stabilized in a preservation solution at a temperature between about −196 and about 30 degrees Celsius, at a temperature between about −100 and about 0 degrees Celsius, at a temperature between about −5 and about 20 degrees Celsius, at a temperature of about 0 to about 20 degrees Celsius, or between about 1 and about 15 degrees Celsius, at a temperature between about 2 and about 8 degrees Celsius, or at a temperature that is maintained at about 4 degrees Celsius. In certain embodiments, the cells are stabilized in a preservation solution that is maintained at a temperature that does not go below −8, −7, −6, −5, −4, −3, −2, −1, or 0 degrees Celsius. In certain embodiments, the temperature of a preservation solution may vary over time, depending on shipping conditions.

In certain embodiments, cells stabilized in a preservation solution can be used for one or more of lineage, cell counts, and gene expression analysis. In certain embodiments, biological samples, including, but not limited to, cells, tissues, biopsies, whole organs, extracellular vesicles, and other microparticles, and blood, stabilized in a preservation solution can be used for single cell or particle analysis of gene, protein, or metabolome expression, or for other downstream processing, e.g., for molecular and/or cellular profiling.

In certain embodiments, a container comprising a dry composition is provided. In certain such embodiments, one or more of the components of the dry composition is lyophilized. In certain embodiments, the dry composition is stable at room temperature for up to 1, 2, 3, 4, 5, 6, 7, 8, 9, 10, 11, 12, 13, 14, 15, 16, 17, 18, 19, 20, 21, 22, 23, or 24 months before use. In certain embodiments, the amount of the components of the dry composition is calculated such that the components reach a desired concentration when combined with a specific amount of blood. For example, and not limitation, components in a 10 ml blood tube can be present in sufficient quantities such that after addition of 10 ml of blood, the resuspended components are present at desired concentrations and at the desired pH.

In certain embodiments, a container comprising a buffered solution is provided. In certain such embodiments, the buffered solution is stable at room temperature for up to 1, 2, 3, 4, 5, 6, 7, 8, 9, 10, 11, 12, 13, 14, 15, 16, 17, 18, 19, 20, 21, 22, 23, or 24 months before use. In certain embodiments, the amount of the components of the buffered solution is calculated such that the components reach a desired concentration when combined with a specific amount of blood. For example, and not limitation, components in 2 ml of buffering solution in a 10 ml blood tube can be present in sufficient quantities such that after addition of 8 ml of blood, the components are present at desired concentrations and at the desired pH. In certain embodiments, the buffered solution can be more or less concentrated to accommodate different amounts of blood. For example, and not limitation, one can design a concentrated buffered solution of 0.5 ml in a 10 ml tube that would reach the desired pH and concentration of components after the addition of 9.5 ml of blood. In certain embodiments, the concentration and volume of the buffered solution is designed to accommodate an anticipated amount of blood. In certain such embodiments, the anticipated amount of blood to combine with the buffered solution is determined by the volume of the container. In certain embodiments, the anticipated amount of blood to combine with the buffered solution is determined by means other than the volume of a container, such as, for example and not limitation, instructions that accompany the buffered solution or markings on the container designating fill levels.

In certain embodiments, a container comprising a dry composition is provided. In certain such embodiments, the dry composition is suspended in a solution by addition of water or other liquid to create a buffered solution. In certain embodiments, a resuspension solution is provided in a second container comprising a sufficient amount of resuspension solution to create a buffered solution in a first container. In certain embodiments, the amount of the components of the buffered solution is calculated such that the components reach a desired concentration when combined with a specific amount of blood. In certain such embodiments, one or more of the components for the buffered solution are provided in the resuspension solution.

In certain embodiments, a container comprising a first solution is provided. In certain such embodiments, the first solution in the container is combined with a second solution to create a buffered solution. In certain embodiments, the amount of the components of the buffered solution is calculated such that the components reach a desired concentration when combined with a specific amount of blood. In certain embodiments, one or more of the components for the buffered solution are provided in the first solution. In certain embodiments, one or more of the components for the buffered solution are provided in the second solution.

Containers used for blood preservation can comprise any container capable of holding blood. Examples of containers include, but are not limited to, tubes, bags, flasks, and bottles. In certain embodiments, a container is coated with at least one component to facilitate blood drawing and blood preservation. Containers can vary in size, including any size containers used for drawing blood. In certain embodiments, containers can be preloaded with preservation solution components calculated to create a preservation solution with appropriate concentrations of components. In certain embodiments, containers are under a vacuum to facilitate blood drawing.

In certain embodiments, a preservation solution is made by adding whole blood to a solution or a dry composition to create a preservation solution. In certain embodiments, a preservation solution is made by adding cells fractionated from blood to a solution or a dry composition to create a preservation solution. In certain embodiments, a preservation solution is made by adding isolated cells to a solution or a dry composition to create a preservation solution.

In certain embodiments, blood is drawn at a first site and the cells are preserved in a preservation solution at that first site. In certain embodiments, the cells are then shipped in the preservation solution from the first site to a second site. In certain such embodiments, at the second site, the cells undergo at least one step of processing, detection, or analysis. In certain embodiments, cells that have undergone at least one step of processing, detection, or analysis at a second site are preserved in a second preservation solution at the second site. In certain such embodiments, the cells are then shipped in the second preservation solution from the second site to either the first site or a third site.

Methods of packaging and shipping biological materials are known in the art. In certain embodiments, packaging and shipping includes one or more of (a) packaging designed to protect the container containing the preservation solution during shipping, (b) a means to keep the preservation solution at a temperature between −5 and 15 degrees Celsius while in the shipping package, and (c) a means to monitor the temperature of the preservation solution during the duration that the preservation solution remains in the shipping package.

Means to refrigerate or otherwise control the temperature of biological materials during the duration that the biological materials remain in the shipping package, such as cold storage devices and systems, are known in the art. In certain embodiments, a device comprising a way to maintain temperature is used. Examples of insulated shipping containers comprising devices that maintain temperature during shipping include, but are not limited to, NanoCool®, Thermosafe® VIP shippers, Pelican Biothermal Credo Cube, and shipping containers comprising gel packs preconditioned to 4 degrees.

Means to monitor and/or control the temperature of biological materials during the duration that the biological materials remain in the shipping package, such as temperature sensors and thermostats, are known in the art. In certain embodiments, a device comprising a way to monitor temperature and track temperature fluctuations over time is used. Examples of devices that can be used to monitor temperature include, but are not limited to, American Thermal Instruments Logic X2 tracker, SensiTech TempTale® monitors, and FlashLink® from DeltaTrack®.

In certain embodiments, a kit is provided comprising one or more components used to stabilize cells in a preservation solution. In certain embodiments, a kit further comprises one or more components for shipping cells in a preservation solution. In certain embodiments a kit is provided comprising a container for collecting a set volume of whole blood comprising a composition, wherein after addition of the set volume of whole blood, the composition comprises: a buffer at a physiological pH between about 6.8 and about 7.6, about 1.5% to about 6% F68, about 5 to about 15 mM lactobionate, and an anti-coagulant. In certain such embodiments, the kit further comprises at least one of about 10 mM Trolox or about 10 mM ascorbic acid. In certain embodiments, a kit further comprises (a) packaging to secure the container containing the preservation solution for shipping, (b) a means to keep the preservation solution at a temperature between 2 and 12 degrees Celsius while in the packaging, and (c) a means to monitor the temperature of the preservation solution during the duration that the preservation solution remains in the shipping package. In certain embodiments, a kit further comprises at least one of: a needle, a syringe, a set of instructions, or a timer. In certain embodiments, at least one container in a kit is provided under vacuum.

In certain embodiments, kits are constructed with components that are stable at room temperature. In certain embodiments, kits are constructed with one or more components that are stable at approximately 4 degrees Celsius. In certain embodiments, kits are constructed with one or more components that are stable when frozen. In certain embodiments, one or more kit components are provided separately from other components. In certain embodiments, one or more kit components are provided as a dry composition. In certain embodiments, one or more kit components are provided as a dry composition that is intended to be suspended in a solution before being combined with blood or another solution. In certain embodiments, one or more kit components are provided as a buffered solution. In certain embodiments, all of the components of a kit are stable at room temperature. In certain embodiments, all of the components in the kit are stable at room temperature and can be stored up to 1, 2, 3, 4, 5, 6, 7, 8, 9, 10, 11, 12, 13, 14, 15, 16, 17, 18, 19, 20, 21, 22, 23, or 24 months before use.

The following examples, which are included herein for illustration purposes only, are not intended to be limiting.

### EXAMPLES

Using a standard venipuncture technique, whole blood was drawn from healthy donors into between one to eight Becton Dickinson (BD) Vacutainers, primarily ACD-A tubes (BD cat. #364606) resulting in 1.5 ml ACD-A solution mixed with 8.5 ml blood. In a few experiments, K2EDTA vacutainers (BD cat. #367863, 6 ml, or #366643, 10 ml) were used for comparison. After blood draw, the tubes were gently inverted approximately 8 times to ensure mixing with the anticoagulants. Tubes were stored at room temperature during transport to the lab for further processing. The following methods and procedures were used in the examples below.

Between 20 minutes to 1 hour after draw, blood was either left untreated or mixed with one of the following buffered solutions designated CWT, CWA, CNA, and BSS:
1. CWT: Buffer of 125 mM HEPES, 1.5% F-68, 50 mM lactobionate and 0-50 mM Trolox, adjusted pH to 7.2 with 1N NaOH. Trolox was diluted from a 200 mM stock solution made by dissolving Trolox powder in either a 7.5% solution of NaHCO3 or a 225 mM solution of NaOH.
2. CWA: Buffer of 125 mM HEPES, 1.5% F-68, 50 mM lactobionate, 0-100 mM ascorbate, adjusted pH to 7.2 with 1N NaOH. In some cases, ascorbate was diluted from a 200 mM solution in 160 mM NaOH. In other cases, ascorbate powder was dissolved directly in the CWA solution.
3. CNA: Buffer of 125 mM HEPES, 1.5% F-68, 50 mM Lactobionate, adjusted pH to 7.2 with 1N NaOH.
4. BSS: Buffer of 137.5 mM HEPES, 1.65% F-68, 55 mM Lactobionate, adjusted pH to 7.2 with 1N NaOH.
   These buffered solutions were added to whole blood in one of the following two ways:
Injection: a standard 18-gauge syringe needle was inserted through the rubber stopper of the Vacutainer blood collection tube to act as a vent (far enough to pierce the cap, but not touch the liquid level inside the tube). A second 18-gauge needle was attached to a 3 ml syringe. The syringe was filled with 2.25 ml buffered solution (CWA or CWT) or a volume between 1.5 and 2.5 ml (for BSS in Example 7), then the solution was injected into the blood tube through a second site in the rubber stopper. After injection, both needles were removed and the tube was inverted gently 8 times to mix completely. Injected tubes were sealed with parafilm and then stored lying on their sides at 4° C. for at least 24 (Day 1) or 48 (Day 2) hours.
Direct mixing: The stoppers were removed from Vacutainer blood collection tubes and blood samples from the same donor were pooled into 50 ml conical tubes or 100 ml glass bottles. The total blood volume was measured and mixed with 0.25 parts of buffered solution CWT, CWA, or CNA (or 0.14 to 0.22 parts of buffered solution BSS). Preservation solution was gently inverted or swirled to mix. For examples requiring storage of preservation solution, preservation solution containing whole blood was aliquoted into 8 ml test tubes (either glass, polystyrene, or polypropylene), capped, sealed with parafilm, and transferred to 4° C. storage as above.

T cells were isolated from non-preserved whole blood or preservation solution by negative selection using EasySep™ Direct Human T Cell Isolation Kit (STEMCELL Technologies #19661). In some cases T cells were also isolated using RosetteSep™ Human T Cell Enrichment Cocktail (STEMCELL Technologies #15061). The resulting purified T cells were quantified using one of three methods:
1. Manual counting, using a hemocytometer slide
2. Automated counting, using the Millipore Scepter 2.0 Handheld Automated Cell Counter
3. Automated counting, using the Bio-Rad TC-20 Automated Cell Counter For Methods 2 and 3, histograms were gated to count cells between 5 and 7 micron.

After counting, cells were pelleted by centrifugation, supernatants were aspirated and discarded and pellets were snap frozen on dry ice, then transferred to −80° C. for storage prior to analysis.

Total RNA was isolated from T cell pellets using the ZR-96 quick-RNA™ kit (Zymo Research; cat. #R1053). RNA was eluted in 50 μl nuclease-free water and RNA concentration was determined by OD260 using Nanodrop ND-8000 spectrophotometer.

cDNA was prepared from up to 400 ng of total RNA using ImProm-II reverse transcriptase (cat #A3803; Promega) and 0.9 μg of random hexamers using manufacturer's protocol. Resulting cDNA reactions were diluted 1:4 with distilled water. 4.4 ul of diluted cDNA was mixed with 5.35 ul of iTar™ Universal Probes Supermix RT-PCR buffer (Bio-Rad, cat #1725134) and 0.25 ul 40× Assay primer/probe mix that are described in the examples below.

Quantitative PCR was performed using a Bio-Rad CFX384 Touch Real-Time PCR Detection System, and data was analyzed using the CFX Manager software (Bio-Rad). Experimental quantitation cycles (Cqs) of 37 or higher were marked as Not Quantifiable (NQ). Relative Quantitation (RQ) values were calculated for target genes in experimental samples using the double delta Ct method (ΔΔCt, see Livak, K J and Schmittgen, T D, 2001, Methods), i.e. normalizing to the housekeeping gene (YWHAZ) and comparing the expression level of the target genes to that obtained in freshly drawn samples for each donor.

### Example 1

Blood samples from ten different donors were drawn into blood collection tubes containing citrate anticoagulant (ACD-A, BD cat. #364606). For each donor, 3 tubes were drawn and the whole blood was pooled together. 6 ml of pooled blood was removed within 4 h of draw (Day 0) for T cell isolation using negative selection (RosetteSep®, StemCell Technologies cat. #15061); cells were pelleted and frozen until analysis. The remaining blood was stored at room temperature for at least 30 h. At the end of incubation, T cells were isolated from duplicate 6 ml aliquots and analyzed together with T cells from Day 0. Gene expression was measured in total RNA isolated from T cells as described above.

Primer/probes sequences: YWHAZ primers:
(SEQ ID NO. 1)
Forward 5′-TGATGACAAGAAAGGGATTG-3′;
(SEQ ID NO. 2)
Reverse 5′-CCCAGTCTGATAGGATGTGTT-3′;
YWHAZ probe
(SEQ ID NO. 3)
5′ 6-FAM-TCGATCAGTCACAACAAGCATACCA-3BHQ1-3′;
CD3G primers:
(SEQ ID NO. 4)
Forward 5′-GAGAGCTTCAGACAAGCAGA-3′;
(SEQ ID NO. 5)
Reverse 5′-TCATCTTCTCGATCCTTGAG-3′;
CD3G probe
(SEQ ID NO. 6)
5′ 6-FAM-TGTTGCCCAATGACCAGCTCT-3BHQ1-3′;
CDKN2A primers:
(SEQ ID NO. 7)
Forward 5′-CCAACGCACCGAATAGTTACG-3′;
(SEQ ID NO. 8)
Reverse 5′-GCGCTGCCCATCATCATG-3′;
CDKN2A probe:
(SEQ ID NO. 9)
5′ 6-FAM-CCTGGATCGGCCTCCGAC-3BHQ1-3′.

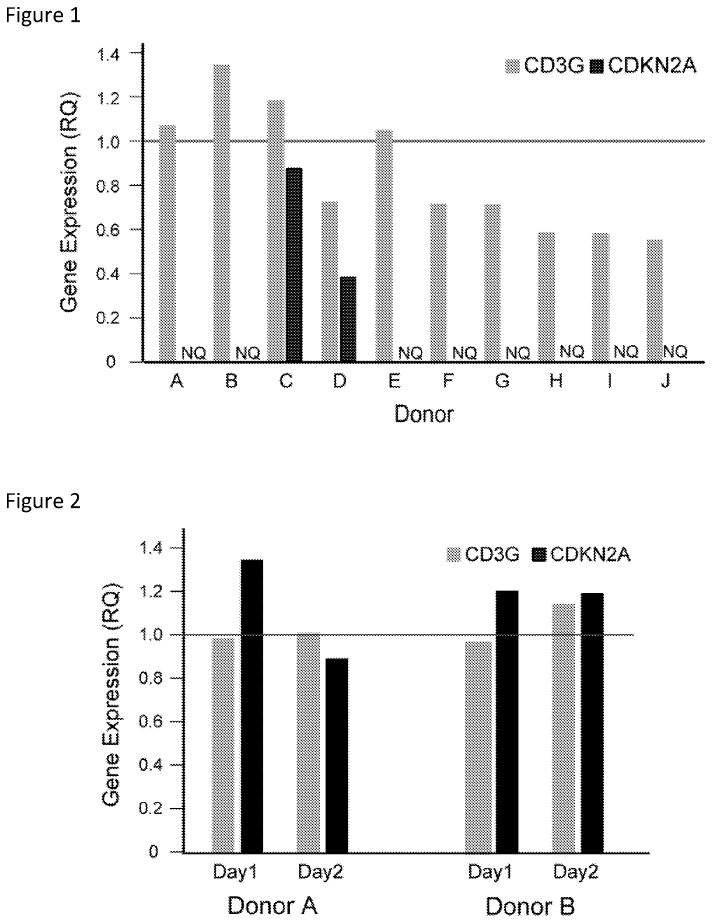

Consistent with the idea that T cells are not well-preserved when stored in whole blood samples, expression of T cell marker (CD3G) was decreased in 6 out of 10 donors, and expression of the intracellular gene, CDKN2A was dramatically reduced (Not Quantifiable (NQ) in 8 out of 10 donors) (FIG. 1 and Table 1).

TABLE 1
Gene expression levels (RQ) in T cells

| Donor | CD3G | CDKN2A |
|---|---|---|
| A | 1.07 | NQ |
| B | 1.35 | NQ |
| C | 1.19 | 0.88 |
| D | 0.72 | 0.38 |
| E | 1.05 | NQ |
| F | 0.71 | NQ |
| G | 0.71 | NQ |
| H | 0.58 | NQ |
| I | 0.58 | NQ |
| J | 0.55 | NQ |

### Example 2

Blood samples from a Donor A and a Donor B were drawn into blood collection tubes containing citrate anticoagulant (ACD-A, BD cat. #364606). For each donor, 6 tubes were drawn and the whole blood was pooled together. Buffered solution (CWA) comprised of 125 mM HEPES, 1.5% F-68, 50 mM lactobionate, 50 mM ascorbate, pH to 7.2 with 1N NaOH. 200 mM stock solution of ascorbate was made by dissolving ascorbate in 160 mM NaOH. CWA buffered solution, made within 24 h of blood draw, was added to whole blood at a ratio of 4 parts blood to 1 part CWA, and mixed by inverting 8 times. 7.5 ml aliquots of preservation solution (buffered solution mixed with whole blood) were taken for T cell isolation within 3 h of draw (Day 0) using EasySep™ Direct Human T Cell isolation Kit (STEMCELL Technologies #19661).

The remaining preservation solution was kept at 4° C. for at least 29 h (Day1) or at least 50 h (Day2). T cells were isolated at each time point as described above and frozen prior to analysis. Gene expression was measured in total RNA isolated from T cells as described above,

Primer/probes sequences: YWHAZ primers:
(SEQ ID NO. 1)
Forward 5′-TGATGACAAGAAAGGGATTG-3′;
(SEQ ID NO. 2)
Reverse 5′-CCCAGTCTGATAGGATGTGTT-3′;
YWHAZ probe
(SEQ ID NO. 3)
5′ 6-FAM-TCGATCAGTCACAACAAGCATACCA-3BHQ1-3′;
CD3G primers:
(SEQ ID NO. 4)
Forward 5′-GAGAGCTTCAGACAAGCAGA-3′;
(SEQ ID NO. 5)
Reverse 5′-TCATCTTCTCGATCCTTGAG-3′;
CD3G probe
(SEQ ID NO. 6)
5′ 6-FAM-TGTTGCCCAATGACCAGCTCT-3BHQ1-3′;
CDKN2A primers:
(SEQ ID NO. 7)
Forward 5′-CCAACGCACCGAATAGTTACG-3′;
(SEQ ID NO. 8)
Reverse 5′-GCGCTGCCCATCATCATG-3′;
CDKN2A probe:
(SEQ ID NO. 9)
5′ 6-FAM-CCTGGATCGGCCTCCGAC-3BHQ1-3′.

Day 0 values were calculated by averaging samples for a given donor from multiple experiments, including some samples of non-preserved whole blood, or samples of preservation solution; no significant difference was observed between these samples. Data for Day2 samples for each donor presented in FIG. 2 represent the average of two experiments. Addition of buffered solution maintains the integrity of T cells as judged by expression of the cell surface marker CD3G as well as the intracellular gene CDKN2A, which are preserved above at least 95% of baseline expression levels for CD3G, and at least 88% of baseline for CDKN2A (FIG. 2 and Table 2).

TABLE 2
Gene expression (RQ) in T cells
isolated from stabilized blood

| | Time | | |
|---|---|---|---|
| Donor | Stored | CD3G | CDKN2A |
| A | Day1 | 0.98 | 1.34 |
| A | Day2 | 1.01 | 0.89 |
| B | Day1 | 0.96 | 1.20 |
| B | Day2 | 1.14 | 1.19 |

### Example 3

Blood samples from a Donor A and a Donor B were drawn into blood collection tubes containing citrate anticoagulant (ACD-A, BD cat. #364606). For each donor, 6 tubes were drawn and the whole blood was pooled together. Buffered solution (here, CWT) contained 125 mM HEPES, 1.5% F-68, 50 mM lactobionate, 50 mM Trolox, pH to 7.2 with 1N NaOH, 200 mM stock solution of Trolox, made by dissolving Trolox powder in either 893 mM NaHCO3 or 225 mM NaOH. No substantial differences were observed between buffered solutions. CWT made within 24 h of blood draw was added to whole blood at a ratio of 4 parts blood to 1 part CWT, and was mixed by inverting 3 times. Duplicate 7.5 ml aliquots of preservation solution were removed for T cells isolation within 3 h hours of draw (Day 0) using EasySep™ Direct Human T Cell Isolation Kit (STEMCELL Technologies #19661). The remaining preservation solution was pipetted in 7.5 ml aliquots into 8 ml tubes, with 4 tubes kept at 4 degrees Celsius, and 4 tubes kept at room temperature. T cells were isolated as described above for duplicate tubes after at least 29 h (Day1) or at least 50 h (Day2), and frozen prior to analysis. Gene expression was measured in total RNA isolated from T cells as described above.

Primer/probes sequences: YWHAZ primers:
(SEQ ID NO. 1)
Forward 5′-TGATGACAAGAAAGGGATTG-3′;
(SEQ ID NO. 2)
Reverse 5′-CCCAGTCTGATAGGATGTGTT-3′;
YWHAZ probe
(SEQ ID NO. 3)
5′ 6-FAM-TCGATCAGTCACAACAAGCATACCA-3BHQ1-3′;
CD3G primers:
(SEQ ID NO. 4)
Forward 5′-GAGAGCTTCAGACAAGCAGA-3′;
(SEQ ID NO. 5)
Reverse 5′-TCATCTTCTCGATCCTTGAG-3′;
CD3G probe
(SEQ ID NO. 6)
5′ 6-FAM-TGTTGCCCAATGACCAGCTCT-3BHQ1-3′;
CDKN2A primers:
(SEQ ID NO. 7)
Forward 5′-CCAACGCACCGAATAGTTACG-3′;
(SEQ ID NO. 8)
Reverse 5′-GCGCTGCCCATCATCATG-3′;
CDKN2A probe:
(SEQ ID NO. 9)
5′ 6-FAM-CCTGGATCGGCCTCCGAC-3BHQ1-3′.

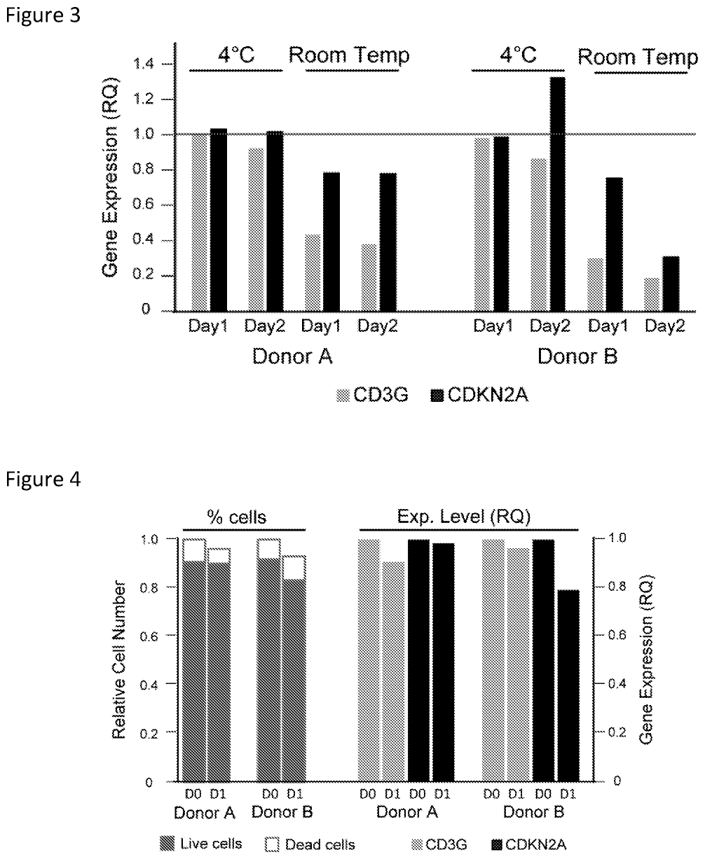

Day 0 values were calculated by averaging samples for a given donor from multiple experiments, including some samples of non-preserved whole blood, or samples of preservation solution; no substantial difference was observed between these samples. Data for Day1 and Day2 samples stored at 4 degrees Celsius for each donor presented in FIG. 3 represent the average of two experiments. Consistent with the results shown in FIG. 2, expression of the T cell marker CD3G and the intracellular gene CDKN2A was preserved at 4° C. (FIG. 3 and Table 3) with amounts greater than 85% of Day 0 values. However, storage at 20° C. resulted in a reduction in preservation to as low as 30% of Day 0 expression levels at Day 1, and as low as 20% of Day 0 levels at Day 2.

TABLE 3
Gene expression levels (RQ) in T cells isolated
From blood stabilized at 4° C. or room temperature

| | Time | | | |
|---|---|---|---|---|
| Donor | Stored | Temp. Stored | CD3G | CDKN2A |
| A | Day1 | 4° C. | 0.99 | 1.03 |
| A | Day2 | 4° C. | 0.92 | 1.01 |
| A | Day1 | Room Temp | 0.43 | 0.78 |
| A | Day2 | Room Temp | 0.38 | 0.77 |
| B | Day1 | 4° C. | 0.97 | 0.98 |
| B | Day2 | 4° C. | 0.86 | 1.32 |
| B | Day1 | Room Temp | 0.30 | 0.75 |
| B | Day2 | Room Temp | 0.19 | 0.30 |

### Example 4

Blood samples from a Donor A and a Donor B were drawn into two ACD-A tubes each. Within 2 h of draw, T cells were isolated from duplicate 6 ml aliquots of whole blood, using EasySep™ Direct Human T Cell isolation Kit (STEMCELL Technologies #19661). Purified T cells were resuspended in PBS+2% fetal bovine serum and counted using the Bio-Rad TC-20 Automated Cell Counter. Live cells were identified using Trypan blue dye. Cells were re-pelleted and resuspended in a 4:1 mixture of PBS+2% fetal bovine serum and buffered solution (here, 125 mM HEPES, 1.5% F-68, 50 mM lactobionate, pH to 7.2 with 1N NaOH) at 1.5-2.5 million total cells/ml. Stabilized T cells were kept at 4° C. for at least 24 h. After the incubation period, total and live T cells were again counted and spun down. Gene expression was measured in total RNA isolated from T cells as described above.

Primer/probes sequences: YWHAZ primers:
(SEQ ID NO. 1)
Forward 5′-TGATGACAAGAAAGGGATTG-3′;
(SEQ ID NO. 2)
Reverse 5′-CCCAGTCTGATAGGATGTGTT-3′;
YWHAZ probe
(SEQ ID NO. 3)
5′ 6-FAM-TCGATCAGTCACAACAAGCATACCA-3BHQ1-3′;
CD3G primers:
(SEQ ID NO. 4)
Forward 5′-GAGAGCTTCAGACAAGCAGA-3′;
(SEQ ID NO. 5)
Reverse 5′-TCATCTTCTCGATCCTTGAG-3′;
CD3G probe
(SEQ ID NO. 6)
5′ 6-FAM-TGTTGCCCAATGACCAGCTCT-3BHQ1-3′;
CDKN2A primers:
(SEQ ID NO. 10)
Forward 5′-CTCGTGCTGATGCTACTGA-3′;
(SEQ ID NO. 11)
Reverse 5′-TCATCATGACCTGGTCTTCT-3′;
CDKN2A probe
(SEQ ID NO. 12)
5′ 6-FAM-AAGCGGCTGCTGCCCTAGAC-3BHQ1-3′.

Day 0 values were calculated by averaging samples for a given donor from multiple experiments, including some samples of non-preserved whole blood, or samples of preservation solution; no substantial difference was observed between these samples. FIG. 4 and Table 4 shows cell counts and gene expression analysis. After 24 h storage (D1), 93-96% of the total number of cells counted at Day 0 (D0) were recovered, of which 89 to 94% were alive (dark grey bar). Consistent with the live T cell counts, expression of the T cell marker CD3G was maintained within 90% of the expression level at Day 0, and expression of intracellular gene CDKN2A was also preserved within at least 79%.

TABLE 4
Cell viability and gene expression of T cells
can be maintained by stabilization buffer

| | | Total cells | Live cells | | |
|---|---|---|---|---|---|
| | Time | recovered, | recovered, | | |
| Donor | point | % | % | CD3G | CDKN2A |
| A | D0 | 100 | 91% | 1.00 | 1.00 |
| A | D1 | 96 | 94% | 0.91 | 0.98 |
| B | D0 | 100 | 92% | 1.00 | 1.00 |
| B | D1 | 93 | 89% | 0.96 | 0.79 |

### EXAMPLE

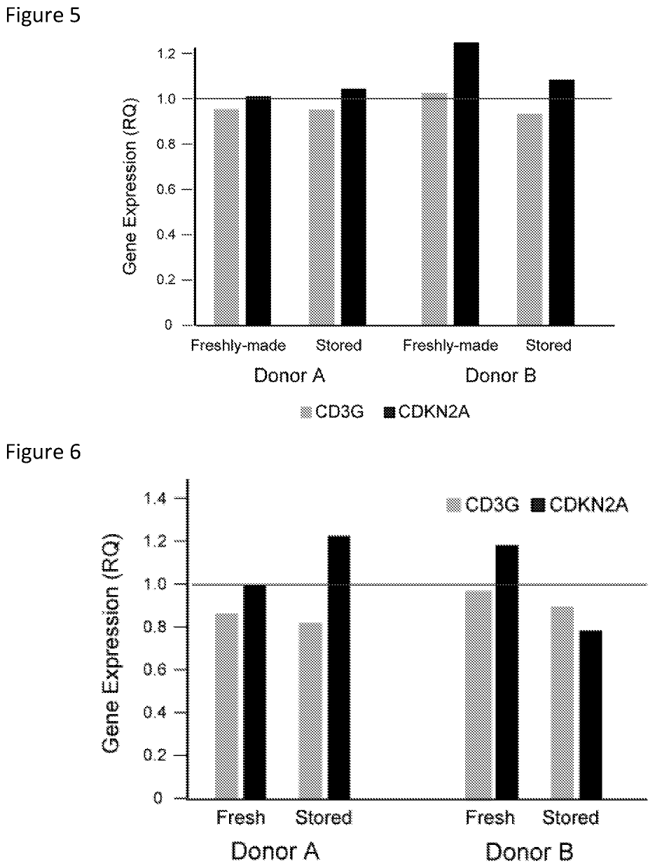

Buffered solution (here, CNA=125 mM HEPES, 1.5% F-68, 50 mM lactobionate, pH to 7.2 with 1N NaOH) was either made one day prior to blood draw (labeled “Freshy-made” in FIG. 5), or made and stored at 20° C. for 5 months (“Stored”). Blood samples from a Donor A and a Donor B were drawn into blood collection tubes containing citrate anticoagulant (ACD-A, BD cat. #364606). For each donor, 4 tubes were drawn and the whole blood was pooled together. Within 1 h of blood draw, fresh buffered solution was added to half of the whole blood at a ratio of 4:1. Buffered solution, made 5 month prior to blood draw date, was added to the other half at the same ratio. All preservation solution samples were mixed by inverting 8 times. Duplicate 7.5 ml aliquots of preservation solution were aliquoted into 8 ml tubes and stored at 4′C for at least 50 h. T cells were then isolated from each sample using the EasySep™ Direct Human T Cell Isolation Kit (STEMCELL Technologies #19661), and frozen prior to analysis. Gene expression was measured in total RNA isolated from T cells as described above.

Primer/probes sequences: YWHAZ primers: Forward 5′-TGATGACAAGAAAGGGATTG-3′ (SEQ ID NO. 1); Reverse 5′-CCCAGTCTGATAGGATGTGTT-3′ (SEQ ID NO. 2); YWHAZ probe 5′ 6-FAM-TCGATCAGTCACAACAAGCATACCA-3BHQ1-3′ (SEQ ID NO. 3); CD3G primers: Forward 5′-GAGAGCTTCAGACAAGCAGA-3′ (SEQ ID NO. 4); Reverse 5′-TCATCTTCTCGATCCTTGAG-3′ (SEQ ID NO.5); CD3G probe 5′ 6-FAM-TGTTGCCCAATGACCAGCTCT-3BHQ1-3′ (SEQ ID NO. 6); CDKN2A primers: Forward 5′-CCAACGCACCGAATAGTTACG-3′ (SEQ ID NO. 7); Reverse 5′-GCGCTGCCCATCATCATG-3′ (SEQ ID NO. 8); CDKN2A probe: 5′ 6-FAM-CCTGGATCGGCCTCCGAC-3BHQ1-3′ (SEQ ID NO. 9).

Day 0 values were calculated by averaging samples for a given donor from multiple experiments, including some samples of non-preserved whole blood, or samples of preservation solution; no substantial difference was observed between these samples. Gene expression data from three previous experiments using freshly-made buffered solution for Donor B were averaged and shown in FIG. 5. Consistent with the results shown in FIGS. 2 and 3, expression of the T cell marker CD3G and the intracellular gene CDKN2A was preserved (FIG. 5 and Table 5) with amounts greater than 93% of Day 0 values, both for samples mixed with freshly-made buffered solution as well as samples mixed with 5 month-old, stored buffered solution.

TABLE 5
Gene expression levels in T cells isolated from blood stabilized with
freshly-made buffered solution or buffered solution stored for 5 months

| Donor | BPS | CD3G | CDKN2A |
|---|---|---|---|
| A | Freshly-made | 0.96 | 1.01 |
| A | Stored | 0.95 | 1.04 |
| B | Freshly-made | 1.03 | 1.25 |
| B | Stored | 0.93 | 1.08 |

### Example 6

Buffer solutions used to prepare blood preservation solutions (BPS) were either made one day prior to blood draw (here, BSS=137.5 mM HEPES, 1.65% F-68, 55 mM Lactobionate, pH to 7.2 with 1N NaOH; labeled “Fresh” in FIG. 6), or made prior to blood draw and stored at room temperature (about 20° C.) for one year (here, CNA=125 mM HEPES, 1.5% F-68, 50 mM Lactobionate, pH to 7.2 with 1N NaOH; labeled “Stored”) (“BSS” and “CNA” were internal designations for buffer solutions used to make BPS). Blood samples from a Donor A and a Donor B were drawn into blood collection tubes containing citrate anticoagulant (ACD-A, BD cat. #364606). For each donor, 4 tubes were drawn and the whole blood was pooled together. Duplicate aliquots of 6 ml blood (without added buffer solutions) were removed for T cell isolation within 3 h of draw (baseline) using EasySep™ Direct Human T Cell Isolation Kit (STEMCELL Technologies #19661). Within 1 h of blood draw, BSS was added to half of the remaining whole blood at a ratio of 9 parts blood to 2 parts BSS, and one-year old stored CNA was added to the other half of the remaining whole blood at a ratio of 4 parts blood to 1 part CNA, so that both mixtures yielded final concentrations in blood of 25 mM HEPES, 0.3% F-68, and 10 mM Lactobionate; both were then mixed by inverting 3 times.

The BPS mixture mixed with BSS was designated the “fresh BPS”. And the BPS mixture mixed with CNA was designated the “stored BPS”. Duplicate samples of “fresh BPS” or “stored BPS” were aliquoted into 7.5 ml tubes and stored at 4° C. for at least 48 h.

T cells were then isolated from each sample using the EasySep™ Direct Human T Cell Isolation Kit (STEMCELL Technologies #19661), and frozen prior to analysis. Total RNA was purified from T cells using the ZR-96 quick-RNA™ kit from Zymo Research (cat. #R1053). cDNA was synthesized from RNA using the ImProm-II™ Reverse Transcription System (Promega #A3803). PCR reactions were set up using TaqMan reagents from Bio-Rad (Bio-Rad, CA) and ThermoFisher Scientific (cat. #4331182). Quantitative PCR was performed using a Bio-Rad CFX384 Touch Real-Time PCR Detection System, and data was analyzed using the CFX Manager software.

Primer/probes sequences: YWHAZ primers: Forward 5′-TGATGACAAGAAAGGGATTG-3′ (SEQ ID NO. 1); Reverse 5′-CCCAGTCTGATAGGATGTGTT-3′ (SEQ ID NO. 2); YWHAZ probe 5′ 6-FAM-TCGATCAGTCACAACAAGCATACCA-3BHQ1-3′ (SEQ ID NO. 3); CD3G primers: Forward 5′-GAGAGCTTCAGACAAGCAGA-3′ (SEQ ID NO. 4); Reverse 5′-TCATCTTCTCGATCCTTGAG-3′ (SEQ ID NO.5); CD3G probe 5′ 6-FAM-TGTTGCCCAATGACCAGCTCT-3BHQ1-3′ (SEQ ID NO. 6); CDKN2A primers: Forward 5′-CCAACGCACCGAATAGTTACG-3′ (SEQ ID NO. 7); Reverse 5′-GCGCTGCCCATCATCATG-3′ (SEQ ID NO. 8); CDKN2A probe: 5′ 6-FAM-CCTGGATCGGCCTCCGAC-3BHQ1-3′ (SEQ ID NO. 9). Cq values of duplicates were averaged, and Relative Quantitation (RQ) values were calculated for experimental samples using the double delta Ct method (ΔΔCt, see Livak and Schmittgen, 2001). Baseline values for each donor were calculated by averaging the duplicate baseline samples in this experiment. Consistent with the results shown in previous figures, expression of the T cell marker CD3G and the intracellular gene CDKN2A was preserved (Table 6 and FIG. 6) with amounts greater than 78% of baseline values, both for samples mixed with fresh buffer solution as well as samples mixed with one year old stored buffer solution.

TABLE 6
Gene expression levels in T-cells isolated from
blood stabilized with freshly-made buffer
solution or buffer solution stored for one year

| Donor | BPS | CD3G | CDKN2A |
|---|---|---|---|
| A | Fresh | 0.86 | 0.98 |
| A | Stored (1 year) | 0.82 | 1.22 |
| B | Fresh | 0.97 | 1.17 |
| B | Stored (1 year) | 0.91 | 0.78 |

### Example 7

Buffer solutions used to prepare blood preservation solution (here, BSS=137.5 mM HEPES, 1.65% F-68, 55 mM Lactobionate, pH to 7.2 with 1N NaOH) was made one day prior to blood draw. Blood samples from a Donor A and a Donor B were drawn into blood collection tubes containing citrate anticoagulant (ACD-A, BD cat. #364606). For each donor, 8 tubes were drawn. Duplicate aliquots of 6 ml blood (without BSS) were removed for T cell isolation within 3 hours of draw (baseline) using EasySep™ Direct Human T Cell Isolation Kit (STEMCELL Technologies #19661). Within 1 hour of blood draw, varying volumes of BSS were injected through the rubber stopper into blood tubes containing about 9 ml blood: 2 duplicates were injected with 1.5 ml BSS (labeled “BSS-A,” corresponding to final concentrations in blood of 20 mM HEPES, 0.2% F-68, and 8 mM Lactobionate); 2 duplicates were injected with 2 ml BSS (labeled “BSS-B”, corresponding to final concentrations in blood of 25 mM HEPES, 0.3% F-68, and 10 mM Lactobionate); and 2 duplicates were injected with 2.5 ml BSS (labeled “BSS-C,” corresponding to final concentrations in blood of 30 mM HEPES, 0.4% F-68, and 12 mM Lactobionate).

All tubes were then sealed with parafilm and mixed by inverting 3 times, then stored at 4° C. for at least 48 hours. T cells were isolated from 7.5 ml from each sample tube using the EasySep™ Direct Human T Cell Isolation Kit (STEMCELL Technologies #19661), and frozen prior to analysis. Total RNA was purified from T cells using the ZR-96 quick-RNA™ kit from Zymo Research (cat. #R1053). cDNA was synthesized from RNA using the ImProm-II™ Reverse Transcription System (Promega #A3803). PCR reactions were set up using TaqMan reagents from Bio-Rad (Bio-Rad, CA) and ThermoFisher Scientific (cat. #4331182). Quantitative PCR was performed using a Bio-Rad CFX384 Touch Real-Time PCR Detection System, and data was analyzed using the CFX Manager software.

Primer/probes sequences: YWHAZ primers:
(SEQ ID NO. 1)
Forward 5′-TGATGACAAGAAAGGGATTG-3′;
(SEQ ID NO. 2)
Reverse 5′-CCCAGTCTGATAGGATGTGTT-3′;
YWHAZ probe
(SEQ ID NO. 3)
5′ 6-FAM-TCGATCAGTCACAACAAGCATACCA-3BHQ1-3′;
CD3G primers:
(SEQ ID NO. 4)
Forward 5′-GAGAGCTTCAGACAAGCAGA-3′;
(SEQ ID NO. 5)
Reverse 5′-TCATCTTCTCGATCCTTGAG-3′;
CD3G probe
(SEQ ID NO. 6)
5′ 6-FAM-TGTTGCCCAATGACCAGCTCT-3BHQ1-3′;
CDKN2A primers:
(SEQ ID NO. 7)
Forward 5′-CCAACGCACCGAATAGTTACG-3′;
(SEQ ID NO. 8)
Reverse 5′-GCGCTGCCCATCATCATG-3′;
CDKN2A probe:
(SEQ ID NO. 9)
5′ 6-FAM-CCTGGATCGGCCTCCGAC-3BHQ1-3′.

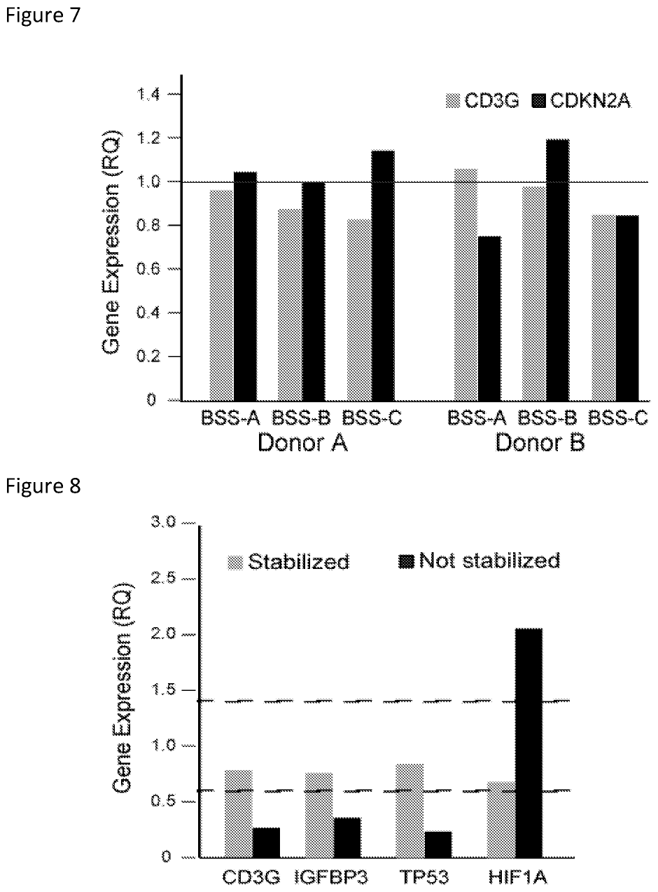

Cq values of duplicates were averaged, and Relative Quantitation (RQ) values were calculated for experimental samples using the double delta Ct method (ΔΔCt, see Livak and Schmittgen, 2001) and comparing the experimental expression level to that obtained in baseline samples for each donor. Baseline values for each donor were calculated by averaging the duplicate baseline samples in this experiment. Consistent with the results shown in previous figures, expression of the T cell marker CD3G and the intracellular gene CDKN2A was preserved (FIG. 7 and Table 7) with amounts greater than 75% of baseline values, with no significant differences observed between the results for different formulations (BSS-A, BSS-B, BSS-C).

TABLE 7
Concentration ranges of buffered solution components used to stabilize whole blood

| | BSS | HEPES, | F68, % | Lactobionate, | | |
|---|---|---|---|---|---|---|
| Donor | Formulation | mM | v/v | mM | CD3G | CDKN2A |
| A | BSS-A | 20 | 0.2 | 8 | 0.96 | 1.03 |
| A | BSS-B | 25 | 0.3 | 10 | 0.86 | 0.98 |
| A | BSS-C | 30 | 0.4 | 12 | 0.83 | 1.11 |
| B | BSS-A | 20 | 0.2 | 8 | 1.04 | 0.75 |
| B | BSS-B | 25 | 0.3 | 10 | 0.97 | 1.17 |
| B | BSS-C | 30 | 0.4 | 12 | 0.84 | 0.84 |

### Example 8

Blood samples from a Donor 1 and a Donor 2 were drawn into blood collection tubes containing citrate anticoagulant (ACD-A, BD cat. #364606). For each donor, 4 tubes were drawn and the whole blood was pooled together. Buffer solution (designated CNA, here: 125 mM HEPES, 1.5% F-68, 50 mM Lactobionate, pH to 7.2 with 1N NaOH) made within 24 hours of blood draw was added to whole blood at a ratio of 4 parts blood to 1 part CNA to create a BPS, and was mixed by inverting 3 times. Duplicate aliquots of 7.5 ml of BPS were removed for T cell isolation within 3 hours of draw (Day 0) using EasySep™ Direct Human T Cell Isolation Kit (STEMCELL Technologies #19661). The remaining BPS was aliquoted into 7.5 ml tubes, with 2 tubes kept at 4 degrees, and 2 tubes kept at room temperature. T cells were isolated using EasySep™ Direct Human T Cell Isolation Kit (STEMCELL Technologies #19661) for duplicate tubes after at least 24 hours, and frozen prior to analysis. Total RNA was purified from T cells using the ZR-96 quick-RNA™ kit from Zymo Research (cat. #R1053). cDNA was synthesized from RNA using the ImProm-II™ Reverse Transcription System (Promega #A3803).

PCR reactions were set up using TaqMan reagents from Bio-Rad (Bio-Rad, CA) and ThermoFisher Scientific (cat. #4453320 and 4448892). Expression of the following genes was analyzed using the following ThermoFisher TaqMan Gene Expression Assays: CD3G (probe described in Example 1), IFGBP3 (insulin like growth factor binding protein 3, ThermoFisher Assay #Hs00426289_m1), TP53 (tumor protein p53, ThermoFisher Assay #Hs01034249_m1), and HIF1A (hypoxia inducible factor 1 alpha subunit, ThermoFisher Assay #Hs00153153_m1). Quantitative PCR was performed using a Bio-Rad CFX384 Touch Real-Time PCR Detection System, and data was analyzed using the CFX Manager software. Cq values of duplicates were averaged, and Relative Quantitation (RQ) values were calculated for experimental samples using the double delta Ct method (ΔΔCt, see Livak and Schmittgen, 2001) and comparing the experimental expression level to that obtained in baseline (Day 0) samples for each donor in this experiment.

For each gene, RQ values for the two donors (shown in Table 1) were averaged, and values for 24-hour samples stabilized by storage at 4° C. were compared to RQ values for unstabilized samples stored 24 hours at room temperature (20° C.) (FIG. 8 and Table 8). 4° C. stabilized samples retained expression levels within 40% of baseline levels (RQs between 0.6 and 1.4 (see dashed lines in FIG. 8)) for all genes. However, for unstabilized samples stored at 20° C., expression levels of CD3G, IFGBP3, and TP53 dropped to at or below one-third of baseline expression (RQs between 0.18 and 0.34), while expression of HIF1A increased 2-fold in unstabilized samples. Thus addition of blood preservation solution and storage at 4° C. preserved (within 40%) baseline levels of T cell gene expression for this panel of genes which otherwise change significantly in unstabilized samples.

TABLE 8
Expression of multiple genes is preserved in T-cells
isolated from blood stabilized with BSS buffer for 24 hours

| Sample | Condition | CD3G | IFGBP3 | TP53 | HIF1A |
|---|---|---|---|---|---|
| Donor A | Stabilized 24 h | 0.9 | 0.9 | 0.9 | 0.7 |
| Donor B | Stabilized 24 h | 0.6 | 0.6 | 0.7 | 0.6 |
| Average | Stabilized 24 h | 0.8 | 0.8 | 0.8 | 0.6 |
| Donor A | Not stabilized 24 h | 0.3 | 0.4 | 0.2 | 2.0 |
| Donor B | Not stabilized 24 h | 0.2 | 0.3 | 0.2 | 2.1 |
| Average | Not stabilized 24 h | 0.2 | 0.3 | 0.2 | 2.0 |

### Example 9

Blood samples from a Donor A and a Donor B were drawn into blood collection tubes containing citrate anticoagulant (ACD-A, BD cat. #364606), and the whole blood for each donor was pooled together. Buffer solution (BSS, here 137.5 mM HEPES, 1.65% F-68, 55 mM Lactobionate, pH to 7.2 with 1N NaOH) made within one month of blood draw was added to whole blood at a ratio of 9 parts blood to 2 parts BSS to create a BPS, and was mixed by inverting 3 times. Within 3 hours of draw (Day 0), duplicate aliquots of 0.875 ml BPS were mixed well with an equal volume of 2×DNA/RNA Shield (Zymo Research, cat. #R1200), then frozen and stored at −80° C. for later RNA isolation. 7 ml of the remaining BPS was aliquoted into four 1.75 ml tubes, with 2 tubes kept at 4 degrees, and 2 tubes kept at room temperature. After at least 24 hours, and then repeated again after at least 48 hours, one tube was split into two duplicates of BPS, and both were combined with 2×DNA/RNA Shield and frozen, as described above for the baseline samples.

Total RNA was purified from all frozen samples in DNA/RNA Shield using the Quick-RNA Whole Blood kit from Zymo Research (cat. #R1201). cDNA was synthesized from RNA using the ImProm-II™ Reverse Transcription System (Promega #A3803). PCR reactions were set up using TaqMan reagents from Bio-Rad (Bio-Rad, CA) and ThermoFisher Scientific (cat. #4453320 and 4448892). Expression of the following genes was analyzed using the following probes or ThermoFisher TaqMan Gene Expression Assays: CD3G (probe described in Example 1), CD16 (Fc fragment of IgG receptor IIIb [FCGR3B], ThermoFisher Assay #Hs04334165_m1), CD19 (Hs01047413_g1), IFGBP3 (insulin like growth factor binding protein 3, ThermoFisher Assay #Hs00426289_m1), TP53 (tumor protein p53, #Hs01034249_m1), and HIF1A (hypoxia inducible factor 1 alpha subunit, ThermoFisher Assay #Hs00153153_m1), and IFNG (interferon gamma, ThermoFisher Assay #Hs00989291_m1).

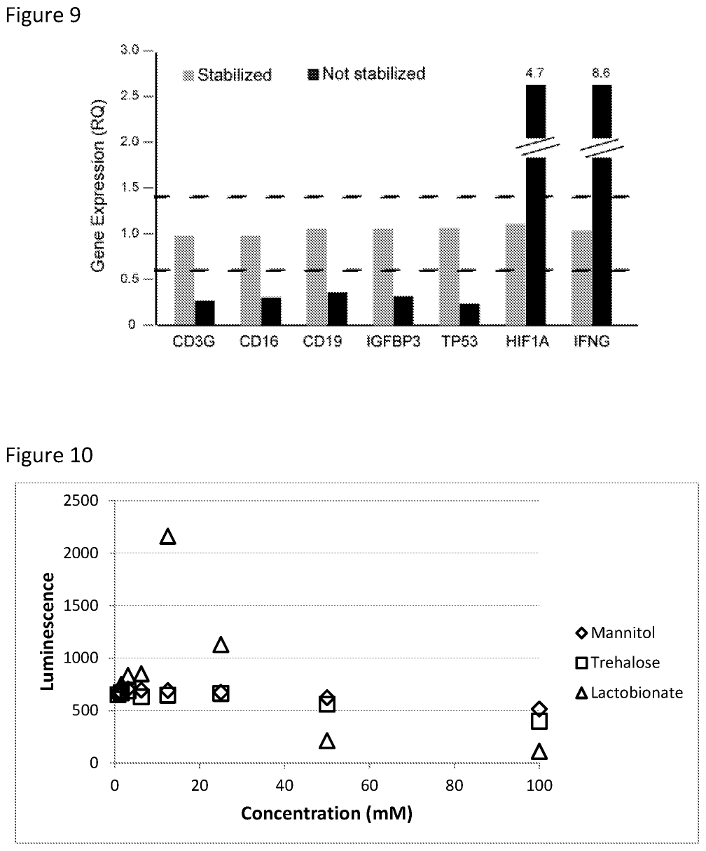

Quantitative PCR was performed using a Bio-Rad CFX384 Touch Real-Time PCR Detection System, and data was analyzed using the CFX Manager software. Cq values of duplicates were averaged, and Relative Quantitation (RQ) values were calculated for experimental samples using the double delta Ct method (ΔΔCt, see Livak and Schmittgen, 2001) and comparing the experimental expression level to that obtained in baseline (Day 0) samples for each donor in this experiment. For each gene, RQ values for the two donors were averaged, and values for 24-hour samples stabilized by storage at 4° C. were compared to RQ values for unstabilized samples stored at room temperature (20° C.)(FIG. 9 (24 hours); and Table 9 (24 hours and 48 hours).

TABLE 9
Expression of multiple genes is preserved in whole blood
stabilized with preservation solution for 24 and 48 hours

| Donor | Condition | CD3G | CD16 | CD19 | IFGBP3 | TP53 | HIF1A | IFNG |
|---|---|---|---|---|---|---|---|---|
| Donor | Stabilized | 1.0 | 1.0 | 1.1 | 0.8 | 1.2 | 0.9 | 1.0 |
| A | 24 h | | | | | | | |
| Donor | Stabilized | 1.0 | 1.0 | 1.0 | 1.3 | 0.9 | 1.3 | 1.1 |
| B | 24 h | | | | | | | |
| Aver- | Stabilized | 1.0 | 1.0 | 1.0 | 1.0 | 1.1 | 1.1 | 1.0 |
| age | 24 h | | | | | | | |
| Donor | Not | 0.3 | 0.3 | 0.4 | 0.2 | 0.2 | 4.7 | 7.9 |
| A | stabilized | | | | | | | |
| | 24 h | | | | | | | |
| Donor | Not | 0.2 | 0.2 | 0.3 | 0.3 | 0.2 | 4.7 | 9.2 |
| B | stabilized | | | | | | | |
| | 24 h | | | | | | | |
| Aver- | Not | 0.3 | 0.3 | 0.3 | 0.3 | 0.2 | 4.7 | 8.6 |
| age | stabilized | | | | | | | |
| | 24 h | | | | | | | |
| Donor | Stabilized | 0.9 | 0.9 | 1.1 | 0.9 | 1.0 | 0.9 | 0.9 |
| A | 48 h | | | | | | | |
| Donor | Stabilized | 1.1 | 1.1 | 1.0 | 1.4 | 1.2 | 1.1 | 0.9 |
| B | 48 h | | | | | | | |
| Aver- | Stabilized | 1.0 | 1.0 | 1.1 | 1.1 | 1.1 | 1.0 | 0.9 |
| age | 48 h | | | | | | | |
| Donor | Not | 0.2 | 0.2 | 0.2 | 0.3 | 0.2 | 10.9 | 35.5 |
| A | stabilized | | | | | | | |
| | 48 h | | | | | | | |
| Donor | Not | 0.2 | 0.2 | 0.2 | 0.3 | 0.2 | 9.3 | 16.1 |
| B | stabilized | | | | | | | |
| | 48 h | | | | | | | |
| Aver- | Not | 0.2 | 0.2 | 0.2 | 0.3 | 0.2 | 10.1 | 25.8 |
| age | stabilized | | | | | | | |
| | 48 h | | | | | | | |

CD3G, CD16 and CD19 are cell surface markers routinely used to identify viable T cells, monocytes and B cells, respectively. IGFBP3, TP53, and HIF1A are genes known to acutely respond to oxidative stress, hypoxia, and DNA damage (See, e.g., Grimberg et al., J. of Clin. Endocrinology & Metabolism, 90(6); 3568-74, 2005). IFNG is a cytokine that is secreted in response to hypoxia by many cell types, including T cells activated under hypoxic conditions (See, e.g., Roman et al., Am. J. Respir. Cell Mol. Biol., 42(1); 123-8, 2010). Maintenance of expression of all of these genes under stabilized conditions suggests that BPS preserves cell viability as well as prevents and/or inhibits changes in cell activation and cytokine release.

After 24 hours, 4° C. stabilized samples retained average expression levels within 12% of baseline levels (RQs between 0.98 and 1.12) for all genes tested, well within the 40% of baseline window (RQs between 0.6 and 1.4, see dashed lines in FIG. 9). However, for unstabilized samples stored 24 hours at 20° C., expression levels of CD3G, CD16, CD19, IFGBP3, and TP53 dropped to at or below one-third of baseline expression (RQs between 0.19 and 0.32), while expression of HIF1A, and IFNG increased between 4.65- to 8.6-fold in unstabilized samples. Likewise, after 48 hours, 4° C. stabilized samples retained average expression levels within 15% of baseline levels (RQs between 0.89 and 1.15) for all genes tested. However, for unstabilized samples stored 48 hours at 20° C., expression levels of CD3G, CD16, CD19, IFGBP3, and TP53 dropped to at or below one-third of baseline expression (RQs between 0.16 and 0.29), while expression of HIF1A, and IFNG increased even more significantly, between 10- to 25-fold in unstabilized samples. Thus, as was observed for gene expression in T cells, baseline levels of gene expression in whole blood, including multiple cell types besides T cells, were preserved (within 15%) in preservation solution during storage at 4° C., for this panel of genes which otherwise change significantly in unstabilized whole blood samples.

### Example 10

Candidate bio-stabilization agents were screened for their ability to preserve various cells types during hypothermic preservation at 4° C. Bio-stabilization agents were classified as either polymers, impermeants, antioxidants, or buffers and several candidates (at various concentrations) in each category were tested and the results are shown in FIGS. 10-13.

For polymers, 0-3% F68, 0-3% PEG 8 KDa, 0-3% Ficoll 70 kDa, and 0-3% Dextran 40 kDa were available for testing. For impermeants, 0-100 mM Lactobionate, 0-100 mM Mannitol, and 0-100 mM Trehalose were available for testing. For antioxidants, 0-10 mM Trolox, 0-10 mM Ascorbic Acid, 0-10 mM Lipoic Acid, 0-10 mM Lipoic Acid/DHLA, 0-10 mM GSH/DHLA, and 0-10 mM NALC were available for testing. For buffers, 0-7.5% weight/volume Sodium Bicarbonate and 0-50 mM HEPES were available for testing.

Stabilization was measured by determining viability of cells using the Cell Titer Glo assay (Catalog No. G9241; Promega). The CellTiter-Glo 2.0 assay determines the number of viable cells in culture by quantifying ATP, which indicates the presence of metabolically active cells, and the luminescence readout is directly proportional to the number of viable cells in culture.

A breast cancer Circulating Tumor Cell (CTC) cell line was added to 96-well plates containing platelet poor plasma and variously treated with different concentrations of bio-stabilization agents. The bio-stabilization agents and combinations of agents tested were serially diluted to create gradients of different bio-stabilization agents across the 96 well plates (as shown in FIGS. 10-13). Cells were kept at a temperature between 2-8° C. for 48 hours in the presence of the bio-stabilization agent and the viability was measured as shown in FIGS. 10-13. A prostate cell line (LNCaP) and various blood cells were also tested with select categories of bio-stabilization agents, confirming the efficacy of some of the bio-stabilization agents on a broad range of cell types.

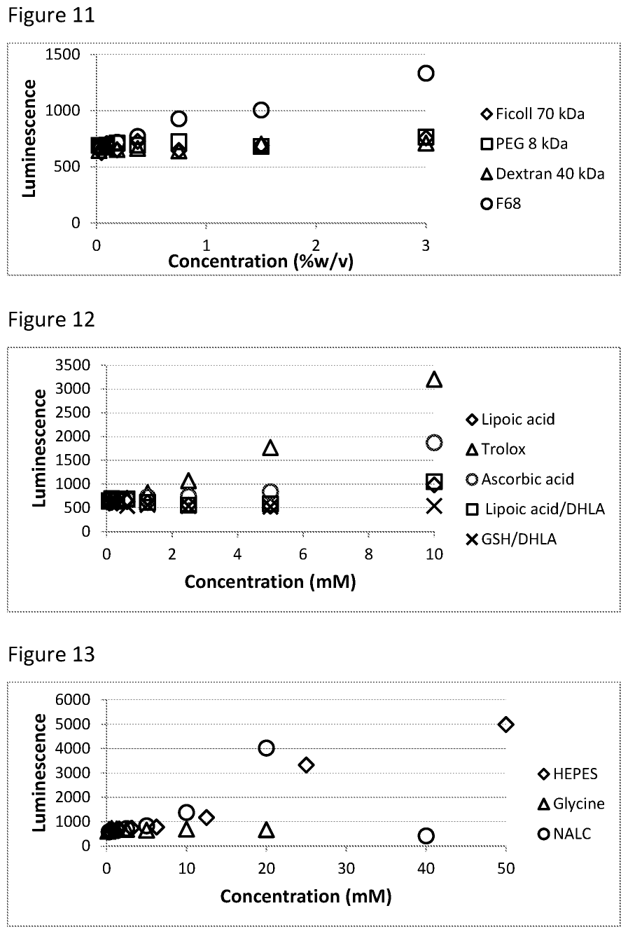

FIG. 10 shows the results of testing various impermeants as a function of concentration. FIG. 11 shows the results of testing various polymers as a function of concentration. FIG. 12 shows the results of testing various antioxidants as a function of concentration. FIG. 13 shows the test results for various buffers and additions as a function of concentration.

### OTHER EMBODIMENTS

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A method of stabilizing cells in a solution, the method comprising combining whole blood with a buffered solution to create a preservation solution, wherein the preservation solution comprises:
the cells,
a buffering agent that produces a physiological pH between 6.8 and 7.6,
0.15%-0.6% F68,
5-15 mM lactobionate,
and an anti-coagulant.

2. A method of claim 1, further comprising storing the preservation solution at a temperature between about −196 and about 30 degrees Celsius or between about −5 and about 15 degrees Celsius.

3. The method of claim 1 or claim 2, wherein the preservation solution comprises 25 mM HEPES at pH 7.2, 0.3% F68, 10 mM lactobionate, 11.2 mM trisodium citrate, 6.2 mM citric acid, and 20.4 mM dextrose.

4. The method of any one of claims 1 to 3, wherein the preservation solution further comprises 10 mM Trolox or 10 mM Ascorbic Acid.

5. The method of any one of claims 1 to 4, wherein the cells comprise one or more of T cells, B cells, macrophages, white blood cells, red blood cells, or circulating cells.

6. The method of any one of claims 1 to 5, wherein combining the whole blood with a buffered solution comprises adding whole blood to a tube comprising the buffered solution at a concentration to create the preservation solution.

7. The method of any one of claims 1 to 6, further comprising preparing a shipping package comprising:
the preservation solution;
a cold storage device to keep the preservation solution at a temperature between −5 and 15 degrees Celsius while in the shipping package; and
a temperature sensor to monitor the temperature of the preservation solution during the duration that the preservation solution remains in the shipping package;
and storing the preservation solution at a temperature between about −5 and about 15 degrees Celsius.

8. The method of any one of claims 1-7, wherein stabilizing the cells comprises preserving cell gene expression or cell protein expression.

9. The method of any one of claims 1-7, wherein stabilizing the cells comprises preserving cell function.

10. A method of stabilizing cells in a solution, the method comprising combining whole blood with a dry composition to create a preservation solution, wherein the preservation solution comprises:
the cells,
a buffering agent that produces a physiological pH between 6.8 and 7.6,
0.15%-0.6% F68,
5-15 mM lactobionate,
and an anti-coagulant.

11. A method of claim 10, further comprising storing the preservation solution at a temperature between about −196 and about 30 degrees Celsius or between about −5 and about 15 degrees Celsius.

12. The method of claim 10 or claim 11, wherein the preservation solution comprises 25 mM HEPES at pH7.2, 0.3% F68, 10 mM lactobionate, 11.2 mM trisodium citrate, 6.2 mM citric acid, and 20.4 mM dextrose.

13. The method of any one of claims 10 to 12, wherein the preservation solution further comprises 10 mM Trolox or 10 mM Ascorbic Acid.

14. The method of any one of claims 10 to 13, wherein the cells comprise one or more of T cells, B cells, macrophages, white blood cells, red blood cells, and circulating cells.

15. The method of any one of claims 01 to 14, wherein combining the whole blood with a dry composition comprises adding whole blood to a tube comprising the dry composition at a concentration to create the preservation solution.

16. The method of any one of claims 10 to 15, further comprising preparing a shipping package comprising:
the preservation solution;
a cold storage device to keep the preservation solution at a temperature between about −5 and about 15 degrees Celsius while in the shipping package;
and a temperature sensor to monitor the temperature of the preservation solution during the duration that the preservation solution remains in the shipping package;
and storing the preservation solution at a temperature between about −5 and about 15 degrees Celsius.

17. The method of any one of claims 10 to 16, wherein stabilizing the cells comprises preserving cell gene expression or cell protein expression.

18. The method of any one of claims 10 to 16, wherein stabilizing the cells comprises preserving cell function.

19. A method of stabilizing T cells in a solution, the method comprising combining the T cells with a buffered solution to create a preservation solution, wherein the preservation solution comprises:
the T cells,
a buffering agent that produces a physiological pH between 6.8 and 7.6,
0.15%-0.6% F68,
5-15 mM lactobionate,
and an anti-coagulant;
and, optionally, storing the preservation solution at a temperature between about −5 degrees and about 15 degrees Celsius.

20. The method of claim 19, wherein the preservation solution comprises 25 mM HEPES at pH7.2, 0.3% F68, 10 mM lactobionate, 11.2 mM trisodium citrate, 6.2 mM citric acid, and 20.4 mM dextrose.

21. The method of claim 19 or claim 20, wherein the preservation solution further comprises 10 mM Trolox or 10 mM Ascorbic Acid.

22. The method of any one of claims 19 to 21, wherein combining the T cells with a buffered solution comprises mixing T cells isolated from whole blood to the buffered solution at a concentration to create the preservation solution.

23. The method of any one of claims 19 to 21, wherein combining the T cells with a buffered solution comprises suspending pelleted T cells in the buffered solution.

24. The method of any one of claims 19 to 21, wherein combining the T cells with a buffered solution comprises adding whole blood to a tube comprising the buffered solution at a concentration to create the preservation solution.

25. The method of any one of claims 19 to 24, further comprising preparing a shipping package comprising:
the preservation solution;
a cold storage device to keep the preservation solution at a temperature between −5 and 15 degrees Celsius while in the shipping package;
and a temperature sensor to monitor the temperature of the preservation solution during the duration that the preservation solution remains in the shipping package;
and storing the preservation solution at a temperature between about −5 and about 15 degrees Celsius.

26. The method of any one of claims 19 to 25, wherein stabilizing the T cells comprises preserving T cell gene expression or T cell protein expression.

27. The method of any one of claims 19 to 26, wherein stabilizing the T cells comprises comparing the expression levels of CD3G, IGFBP3, TP53, and HIF1A in T cells in a preservation solution to baseline expression levels of those markers; and, if the expression levels of CD3G, IGFBP3, TP53, and HIF1A in the T-cells in a preservation solution are within 40% of baseline, concluding that the T-cells have been stabilized.

28. The method of any one of claims 19 to 27, wherein stabilizing the T cells comprises preserving T cell function or T cell counts.

29. A method of stabilizing T cells in a solution, the method comprising combining the T cells with a dry composition to create a preservation solution, wherein the preservation solution comprises:
the T cells,
a buffering agent that produces a physiological pH between 6.8 and 7.6,
0.15%-0.6% F68,
5-15 mM lactobionate,
and an anti-coagulant;
and, optionally, storing the preservation solution at a temperature between about −5 and about 15 degrees Celsius.

30. The method of claim 29, wherein the preservation solution comprises 25 mM HEPES at pH7.2, 0.3% F68, 10 mM lactobionate, 11.2 mM trisodium citrate, 6.2 mM citric acid, and 20.4 mM dextrose.

31. The method of claim 29 or claim 30, wherein the preservation solution further comprises 10 mM Trolox or 10 mM Ascorbic Acid.

32. The method of and one of claims 29 to 31, wherein combining the T cells with a dry composition to create a preservation solution comprises adding T cells suspended in a resuspension solution to the dry composition to create a preservation solution.

33. The method of any one of claims 29 to 31, wherein combining the T cells with a dry composition to create a preservation solution comprises suspending the dry composition in a resuspension solution and adding the resuspension solution to the T cells.

34. The method of any one of claims 29 to 31, wherein combining the T cells with a dry composition to create a preservation solution comprises adding whole blood to a tube comprising the dry composition at a concentration to create the preservation solution.

35. The method of any one of claims 29 to 34, further comprising preparing a shipping package comprising:
the preservation solution;
a cold storage device to keep the preservation solution at a temperature between about −5 and about 15 degrees Celsius while in the shipping package;
and a means to monitor the temperature of the preservation solution during the duration that the preservation solution remains in the shipping package;
and storing the preservation solution at a temperature between about −5 and about 15 degrees Celsius.

36. The method of any one of claims 29 to 35, wherein stabilizing the T cells comprises preserving T-cell gene expression or T-cell protein expression.

37. The method of any one of claims 29 to 36, wherein stabilizing the T cells comprises comparing the expression levels of CD3G, IGFBP3, TP53, and HIF1A in T cells in a preservation solution to baseline expression levels of those markers; and, determining that the T cells are stabilized if the expression levels of CD3G, IGFBP3, TP53, and HIF1A in the T cells in the preservation solution are within 40% of baseline.

38. The method of any one of claims 29 to 37, wherein stabilizing the T cells comprises preserving T-cell function.

39. A method of stabilizing peripheral blood mononucleated cells in a solution, the method comprising combining the peripheral blood mononucleated cells with a buffered solution to create a preservation solution, wherein the preservation solution comprises:
the peripheral blood mononucleated cells,
a buffering agent that produces a physiological pH between 6.8 and 7.6,
0.15%-0.6% F68,
5-15 mM lactobionate,
and an anti-coagulant;
and, optionally, storing the preservation solution at a temperature between about −5 and about 15 degrees Celsius.

40. The method of claim 39, wherein the preservation solution comprises 25 mM HEPES at pH7.2, 0.3% F68, 10 mM lactobionate, 11.2 mM trisodium citrate, 6.2 mM citric acid, and 20.4 mM dextrose.

41. The method of claim 39 or claim 40, wherein the preservation solution further comprises 10 mM Trolox or 10 mM Ascorbic Acid.

42. The method of any one of claims 39 to 41, wherein combining the peripheral blood mononucleated cells with a buffered solution comprises mixing peripheral blood mononucleated cells isolated from whole blood to the buffered solution at a concentration to create the preservation solution.

43. The method of any one of claims 39 to 41, wherein combining the peripheral blood mononucleated cells with a buffered solution comprises suspending pelleted peripheral blood mononucleated cells in the buffered solution.

44. The method of any one of claims 39 to 41, wherein combining the peripheral blood mononucleated cells with a buffered solution comprises adding whole blood to a tube comprising the buffered solution at a concentration to create the preservation solution.

45. The method of any one of claims 39 to 44, further comprising preparing a shipping package comprising:
the preservation solution;
a cold storage device to keep the preservation solution at a temperature between about −5 and about 15 degrees Celsius while in the shipping package;
and a means to monitor the temperature of the preservation solution during the duration that the preservation solution remains in the shipping package;
and storing the preservation solution at a temperature between about −5 and about 15 degrees Celsius.

46. The method of any one of claims 39 to 45, wherein stabilizing the peripheral blood mononucleated cells comprises preserving T cell gene expression or T cell protein expression.

47. The method of any one of claims 39 to 45, wherein stabilizing the peripheral blood mononucleated cells comprises comparing the expression levels of CD3G, IGFBP3, TP53, and HIF1A in peripheral blood mononucleated cells in a preservation solution to baseline expression levels of those markers; and, determining that the peripheral blood mononucleated cells are stabilized if the expression levels of CD3G, IGFBP3, TP53, and HIF1A in the peripheral blood mononucleated cells in the preservation solution are within 40% of baseline.

48. The method of any one of claims 39 to 45, wherein stabilizing the peripheral blood mononucleated cells comprises comparing the expression levels of CD3G, CD16, CD19, IGFBP3, TP53, and HIF1A in peripheral blood mononucleated cells in a preservation solution to baseline expression levels of those markers; and, determining that the peripheral blood mononucleated cells are stabilized if the expression levels of CD3G, CD16, CD19, IGFBP3, TP53, and HIF1A in the peripheral blood mononucleated cells in the preservation solution are within 40% of baseline.

49. The method of any one of claims 39 to 45, wherein stabilizing the peripheral blood mononucleated cells comprises preserving T cell function or T cell counts.

50. A method of stabilizing peripheral blood mononucleated cells in a solution, the method comprising combining the peripheral blood mononucleated cells with a dry composition to create a preservation solution, wherein the preservation solution comprises:
the peripheral blood mononucleated cells,
a buffering agent that produces a physiological pH between 6.8 and 7.6,
0.15%-0.6% F68,
5-15 mM lactobionate,
and an anti-coagulant;
and, optionally, storing the preservation solution at a temperature between about −5 and about 15 degrees Celsius.

51. The method of claim 50, wherein the preservation solution comprises 25 mM HEPES at pH7.2, 0.3% F68, 10 mM lactobionate, 11.2 mM trisodium citrate, 6.2 mM citric acid, and 20.4 mM dextrose.

52. The method of claim 50 or claim 51, wherein the preservation solution further comprises 10 mM Trolox or 10 mM Ascorbic Acid.

53. The method of any one of claims 50 to 52, wherein combining the peripheral blood mononucleated cells with a dry composition to create a preservation solution comprises adding peripheral blood mononucleated cells suspended in a resuspension solution to the dry composition to create a preservation solution.

54. The method of any one of claims 50 to 52, wherein combining the peripheral blood mononucleated cells with a dry composition to create a preservation solution comprises suspending the dry composition in a resuspension solution and adding the resuspension solution to the peripheral blood mononucleated cells.

55. The method of any one of claims 50 to 52, wherein combining the peripheral blood m5ononucleated cells with a dry composition comprises adding whole blood to a tube comprising the dry composition at a concentration to create the preservation solution.

56. The method of any one of claims 50 to 55, further comprising preparing a shipping package comprising:
the preservation solution;
a cold storage device to keep the preservation solution at a temperature between about −5 and about 15 degrees Celsius while in the shipping package;
and a temperature sensor to monitor the temperature of the preservation solution during the duration that the preservation solution remains in the shipping package;
and storing the preservation solution at a temperature between about −5 and about 15 degrees Celsius.

57. The method of any one of claims 50 to 56, wherein stabilizing the peripheral blood mononucleated cells comprises preserving T-cell gene expression or T-cell protein expression.

58. The method of any one of claims 50 to 56, wherein stabilizing the peripheral blood mononucleated cells comprises comparing the expression levels of CD3G, IGFBP3, TP53, and HIF1A in peripheral blood mononucleated cells in a preservation solution to baseline expression levels of those markers; and, determining that the peripheral blood mononucleated cells are stabilized if the expression levels of CD3G, IGFBP3, TP53, and HIF1A in the peripheral blood mononucleated cells in the preservation solution are within 40% of baseline.

59. The method of any one of claims 50 to 56, wherein stabilizing the peripheral blood mononucleated cells comprises comparing the expression levels of CD3G, CD16, CD19, IGFBP3, TP53, and HIF1A in peripheral blood mononucleated cells in a preservation solution to baseline expression levels of those markers; and, determining that the peripheral blood mononucleated cells are stabilized if the expression levels of CD3G, CD16, CD19, IGFBP3, TP53, and HIF1A in the peripheral blood mononucleated cells in the preservation solution are within 40% of baseline.

60. The method of any one of claims 50 to 56, wherein stabilizing the peripheral blood mononucleated cells comprises preserving T-cell function.

61. A composition for the stabilization of cells within a specific volume of whole blood, wherein after addition of the specific volume of whole blood, the composition comprises:
one or more buffering agents at a concentration effective to produce a physiological pH between 6.8 and 7.6,
0.15%-0.6% F68,
5-15 mM lactobionate,
and an anti-coagulant.

62. The composition of claim 61, wherein after the addition of the whole blood, the composition comprises 25 mM HEPES at pH7.2, 0.3% F68, 10 mM lactobionate, 11.2 mM trisodium citrate, 6.2 mM citric acid, and 20.4 mM dextrose.

63. The composition of claim 62 or claim 62, wherein the composition for the stabilization of cells is stable when stored for up to 12 months prior to the addition of the whole blood.

64. The composition of any one of claims 61 to 63, wherein after the addition of the whole blood, the composition further comprises 10 mM Trolox or 10 mM Ascorbic Acid.

65. A composition for the stabilization of cells suspended within a specific volume of a solution, wherein after addition of the specific volume of the solution, the composition comprises:
one or more buffering agents at a concentration effective to produce a physiological pH between 6.8 and 7.6,
0.15%-0.6% F68,
5-15 mM lactobionate,
and an anti-coagulant.

66. The composition of claim 65, wherein after the addition of the solution, the composition comprises 25 mM HEPES at pH7.2, 0.3% F68, 10 mM lactobionate, 11.2 mM trisodium citrate, 6.2 mM citric acid, and 20.4 mM dextrose.

67. The composition of claim 65 or claim 66, wherein the composition for the stabilization of cells is stable when stored for up to 12 months prior to the addition of the solution.

68. The composition of any one of claims 65 to 67, wherein after the addition of the solution, the composition further comprises 10 mM Trolox or 10 mM Ascorbic Acid.

69. A kit for stabilizing cells comprising:
a) a container for collecting a set volume of whole blood comprising a composition, wherein after addition of the set volume of whole blood, the composition comprises:
one or more buffering agents at a concentration effective to produce a physiological pH between 6.8 and 7.6,
0.15%-0.6% F68,
5-15 mM lactobionate,
and an anti-coagulant;
b) packaging to secure the container containing the preservation solution for shipping;
c) a cold storage device to keep the preservation solution at a temperature between about −5 and about 15 degrees Celsius while in the packaging; and
d) a temperature sensor to monitor the temperature of the preservation solution during the duration that the preservation solution remains in the shipping package.

70. The kit of claim 69, wherein the container comprises a tube or a bag, and optionally, wherein the container is under vacuum prior to the addition of the set volume of whole blood.

71. The kit of claim 69 or claim 70, wherein the kit further comprises at least one of: a needle, a syringe, a set of instructions, or a timer.

72. The kit of any one of claims 69 to 71, wherein after addition of the set volume of whole blood, the composition comprises 25 mM HEPES at pH7.2, 0.3% F68, 10 mM lactobionate, 11.2 mM trisodium citrate, 6.2 mM citric acid, and 20.4 mM dextrose.

73. The kit of any one of claims 69 to 72, wherein after addition of the set volume of whole blood, the composition further comprises 10 mM Trolox or 10 mM Ascorbic Acid.

74. A kit for stabilizing cells comprising:
a) a container for collecting a set volume of whole blood comprising a buffered solution, wherein a preservation solution is formed after addition of the set volume of whole blood, wherein the preservation solution comprises:
cells,
one or more buffering agents at a concentration effective to produce a physiological pH between 6.8 and 7.6,
0.15%-0.6% F68,
5-15 mM lactobionate,
and an anti-coagulant;
b) packaging to secure the container containing the preservation solution for shipping;
c) a cold storage device to keep the preservation solution at a temperature between about −5 and about 15 degrees Celsius while in the packaging; and
d) a temperature sensor to monitor the temperature of the preservation solution during the duration that the preservation solution remains in the shipping package.

75. The kit of claim 74, wherein the container comprises a tube.

76. The kit of claim 74, wherein the container comprises a bag.

77. The kit of any one of claims 74 to 76, wherein the container is under vacuum prior to the addition of the set volume of whole blood.

78. The kit of any one of claims 74 to 77, wherein the kit further comprises at least one of: a needle, a syringe, a set of instructions, or a timer.

79. The kit of claim any one of claims 74 to 78, wherein after addition of the set volume of whole blood, the composition comprises 25 mM HEPES at pH7.2, 0.3% F68, 10 mM lactobionate, 11.2 mM trisodium citrate, 6.2 mM citric acid, and 20.4 mM dextrose.

80. The kit of any one of claims 74 to 79, wherein after addition of the set volume of whole blood, the composition further comprises 10 mM Trolox or 10 mM Ascorbic Acid.

81. A method of stabilizing a biological sample, the method comprising obtaining a biological sample from a subject and introducing the following bio-stabilization agents to the biological sample to create a preservation solution:
a) at least one anti-shearing agent;
b) at least one impermeant, optionally, wherein the impermeant comprises one or both of trehalose or lactobionate; and
c) one or more of:
i) a buffering solution;
ii) at least one antioxidant;
iii) at least one anti-coagulant;
iv) at least one anti-inflammatory agent; and
v) at least one nutrient supplement.

82. The method of claim 81, wherein the at least one anti-shearing agent is selected from one or more of F68, Ficoll 70 kDa, Dextran 40 kDa, and PEG 8 kDa.

83. The method of claim 81 or claim 82, wherein the buffering solution comprises HEPES or Sodium Bicarbonate.

84. The method of any one of claims 81 to 83, wherein the at least one antioxidant is selected from one or more of Trolox, NALC, Ascorbic Acid, Lipoic Acid, Lipoic Acid/DHLA, and GSH/DHLA.

85. The method of any one of claims 81 to 84, wherein the at least one anti-coagulant is selected from one or more of citrate and EDTA.

86. The method of any one of claims 81 to 85, wherein the at least one anti-inflammatory agent is dexamethasone.

87. The method of any one of claims 81 to 86, wherein the at least one nutrient supplement is selected from platelet poor plasma and a cell culture media.

88. The method of any one of claims 81 to 87, wherein the biological sample is blood.

89. The method of any one of claims 81 to 88, wherein the preservation solution is stored at a temperature between about 2° C. and about 8° C. for up to 72 hours.

90. The method of any one of claims 81 to 89, wherein the at least one anti-shearing agent is added to produce a final concentration of up to about 10% w/v of the at least one anti-shearing agent in the preservation solution.

91. The method of any one of claims 81 to 90, wherein the at least one impermeant is added to achieve a final concentration of up to about 150 mM in the preservation solution.

92. The method of any one of claims 81 to 91, wherein the at least one antioxidant is added to achieve a final concentration of up to about 250 mM in the preservation solution.

93. A composition for stabilizing cells in a solution, the composition comprising an ACD anticoagulant, a platelet inhibitor, e.g., tirofiban, e.g., 0.5 ug/mL tirofiban, and about 0.25% to about 3% Ficoll70.

94. The composition of claim 93, further comprising about 10 mM Trolox, about 10 mM Lactobioante, about 25 mM HEPES, and about 0.3% F68.

95. A composition for stabilizing cells in a solution, the composition comprising an ACD anticoagulant, a platelet inhibitor, e.g., tirofiban, e.g., 0.5 ug/mL tirofiban, about 10 mM Trolox, about 10 mM Lactobioante, about 25 mM HEPES, and about 0.3% F68.
